(19) United States
(12) Patent Application Publication
(10) Pub. No.: US 2008/0013829 A1
(43) Pub. Date: Jan. 17, 2008

(54) System and method for the identification of motional media in players and recorders without Internet access

(76) Inventor: David W. Stebbings, Fairfax, VA (US)

Correspondence Address: WILMERHALE/NEW YORK, 399 PARK AVENUE, NEW YORK, NY, 10022, US

(21) Appl. No.: 11/728,948

(22) Filed: Mar. 27, 2007

Related U.S. Application Data
(60) Provisional application No. 60/786,812, filed on Mar. 28, 2006.
(60) Provisional application No. 60/792,749, filed on Apr. 18, 2006.

(51) Int. Cl. G06K 9/00

(52) U.S. Cl. 382/172

(57) ABSTRACT

One or more embodiments of the present invention is directed to systems and methods that identify motional media content from the actual initially unknown program under review. Embodiments of the present invention identifies the content by searching a database to derive the relevant information about the owner, copyright holder and other pertinent facts such as copy and play permissions. It further provides methods for deriving the frame or picture count between shot or scene changes, the sequence of numbers or vectors having been already established from an original master or copy is provided. A system according to one or more embodiments of the present invention ensures that the probability of false negative or positive detection of the media is very small and then creates methods that reduce the information that is used to identify the media. A method according to one or more embodiments of the present invention is extremely robust against attempts of circumvention.

### RELATED APPLICATIONS

This application claims priority to U.S. provisional patent application No. 60/786,812, titled “SYSTEM AND METHOD FOR THE IDENTIFICATION OF MOTIONAL MEDIA IN PLAYERS AND RECORDERS WITHOUT INTERNET ACCESS” filed on Mar. 28, 2006, co-pending U.S. patent application Ser. No. 60/792,749, titled “SYSTEM AND METHOD FOR THE IDENTIFICATION OF MOTIONAL MEDIA OF WIDELY VARYING PICTURE CONTENT” filed on Apr. 18, 2006, and co-pending U.S. patent application Ser. No. 11/431,654, titled “SYSTEM AND METHOD FOR THE IDENTIFICATION OF MOVIES, OR ANY MOTIONAL VISUAL CONTENT” filed May 11, 2006, and which claims priority to U.S. Provisional Patent Application No. 60/682,011, filed on May 18, 2005, all of which are incorporated herein by reference in its entirety for all purposes.

### BACKGROUND OF THE INVENTION

1. Field of the Invention

The present invention is directed to computer related and/or assisted system, method, computer readable medium and program for Intellectual Property Detection. More particularly, the present invention relates to systems and methods for identifying electronic motional media files with a fast and computationally small mathematical algorithm. Derived identifiers can be used to search a database that contains identifiers of many files and thus assign the ownership and copyright holder to that particular content. The invention relates to a reduction of the data entry in the database such that many identifiers can be pre-loaded into a media player or recorder, or ROM drive or mobile devices each with associated information, artist details, promotions, and permissions that are created by the copyright holder.

2. Background Description

In recent years Intellectual Property (IP) concerning video and audio content has become an important issue for at least two reasons. First, it is the product of an industry worth multi-billion dollars per annum and is one of the leaders in United States exports and, second, because theft of valuable IP assets is rampant worldwide. IP theft of video and audio content mostly includes counterfeiting, illegal reproduction, over production of discs, piracy, bootlegging and nowadays, illegal Internet file distribution, and it is international in scale and scope.

In the case of the motional visual arts, games and audio, the advent of the CD video (CDV), and now the Digital Versatile Disc (DVD), High-Definition DVD (HD-DVD), Blu-ray discs (BD), High-Definition television (HDTV) and other new technologies have exacerbated the problem.

One aspect of Intellectual property concerning video and audio content is that it provides enjoyment, entertainment and often education to the recipient. Various systems are in place today to enhance this experience. In order to provide such enhancing experiences, Intellectual Property rights associated with video and audio contents are identified in each individual case. Without such identification, additional information, such as dates of creation, information about the performing artists, copyright information and a myriad of other information that the recipient may want to know, cannot be supplied.

For these other reasons, there is a need for a simple and speedy way to identify Intellectual Property in general and, more particularly, Motional Media.

The present invention is directed to solving one or more of these problems since in at least one embodiment, prior processing of the media is not involved and/or, therefore, there are no codes to bury. Furthermore, in alternative embodiments, the present invention detects media identities, irrespective of format, quality, origin such as bootleg, editing and other changes to, or abuses of, the original production. The present invention can identify, for example, movies that run backwards in time, movies that are displayed upside down and/or at an angle, movies taken by a camera from a live display, or movies that are very low bit-rate encoded with repeated, interpolated or omitted pictures.

3. Description of Prior Art

Various methods have been devised to identify Intellectual Property with varying degrees of success. One well known technique has been the use of “Watermarks.” Watermarking seeks to “bury” a secret code in the visual media that is invisible to the eye. In some instances, watermarking embeds a secret code in the audio that is inaudible to the ear. The secret code is then rediscovered by processing the content with a mathematical algorithm. In many proposals the necessary computation rate has been high since they often involve Discrete Cosine Transforms (DCT's) or Fast Fourier Transforms (FFT's), and associated refinements of these well known computational methods. They have been adapted to speed up the process, and give increased robustness against circumvention and visibility. In such adaptations, the watermarks have been compromised.

The code can also be configured in many ways to include IP details of the associated media. These technologies have been proposed by many, including the principal companies of the DVD Forum. One aspect of Intellectual property concerning video and audio content is that it provides enjoyment, entertainment and often education to the recipient. Various systems are in place today that enhance this experience. In order to provide such enhancing experiences, Intellectual Property rights associated with video and audio contents are identified in each individual case. Without such identification, additional information, such as dates of creation, information about the performing artists, copyright information and a myriad of other details that the recipient may want to know, cannot be supplied.

For these and other reasons, there is a need for a simple and speedy way to identify Intellectual Property in general and, more particularly, Motional Media.

Unfortunately there are several severe limitations to the existing types of system. The first is the difficulty of making the watermark invisible irrespective of the detailed nature of the content. The second is the amount of mathematical signal processing needed to extract the watermark and the information therein. Microprocessors of ever-higher power help to assuage this problem but require electronic support structures. The third is that decoders are necessary that have a set of rules, either built-in or have other access to the information, to act on the extracted rules. Exemplary rules include no playing or copying allowed, one or multiple copies allowed, and the like. The fourth is that the watermarks are not robust to editing, or standards changes, for example, displays in Color that are transformed to Black and White (or vice-versa), HDTV to conventional 4/3 or 5/4-ratio picture, time dilation or aspect ratio change, bootlegged copies etc., and other forms of manipulation. Watermarks are, in general, lost in many of these types of common processes. The fifth is that not all watermarks are robust in certain types of picture. For example, detailed structure of a given picture affects the detection ability of the watermark, or raising insertion level of the watermark in order to ensure detection increases the danger of the watermark becoming visible and, thus, interferes with the picture quality.

Furthermore, originals or bootleg copies of the original media can be made even before a watermark is inserted by the studio. In these instances, there is no information to de-code. There have been several recent cases where this has occurred with prominent movies. The present invention in accordance with some embodiments is directed to solving one or more of these watermark problems when prior processing of the media is not involved, when code is not buried, or when the media is un-readable.

Another technique described in the prior art that is used to identify motional and audio media is a method known as “fingerprinting.” These methods seek to emulate the uniqueness of the human fingerprint and apply similar concepts to motional and audio media. The system applies a mathematical algorithmic technique to derive short identifiers from the media by using what is designed to be a significant perceptual assessment of the content. Therefore different researchers have their own ideas on the importance of various perceptual parameters and build an algorithm to derive measurements in question. Unlike the human fingerprint in which one is a sufficient and complete identity, because media varies as a function of time, fingerprints are derived throughout the work, so that discovery can occur wherever the search starts. The concept is to reduce the amount of data for the fingerprints when compared to that of the original work. When a fingerprint is obtained, it is compared with those from the same work in a database and if a match is obtained an identity is discovered.

The problem with this methodology is that the derivations of the fingerprint by the prior art methods require considerable processing by the algorithm. A useful number is the ratio of the total fingerprint data for a file compared to that of the original. Compression ratios so obtained are anything from about 50 to one for an MP3 or MPEG-4 file to about a thousand to one, that depends on several factors such as how significantly the original file was bit-rate reduced. At these ratios the database holding the reference fingerprints for a million files is very large, especially for motional media, and search times are extended. Furthermore the processing involved to derive the fingerprint is intensive and cannot ran easily at a rate that is faster than real time. Conventional fingerprint technologies derive unique identifiers by processing pictures or a group of pictures. These systems derive what is hoped to be a unique set of coefficients or numbers that can be used to identify unknown content by a search in an appropriate database. However, in a large library, for example, with a million titles, the number of fingerprints that are derived or may be derivable can run to several hundred billion or up to a trillion or more. Although the pictures are derived from infinite sources, many fingerprints, in practice, will be fairly similar because majority of pictures will be of average brightness, gain, color, hue and saturation for instance. This is generally not a problem with perfect sources and content. However, when the source is distorted, for example by changes in format, by reduced quality, boxing of the display, blurred camera derived pictures or angular distortions of the images or other added components such as sub titles in different languages, the conventional methods can get into difficulties.

### SUMMARY OF EMBODIMENTS OF THE INVENTION

The present invention addresses and applies novel technology to alleviate one or more of the aforementioned problems. The present invention solves one or more of these problems in accordance with some embodiments by deriving a fingerprint using a method that allows very high compression ratios for data capacity of a fingerprint file compared to data of an original media file. For example, the ratio may be as high as a million to one for compressed motional media should full advantage of the system is used (or up to tens of millions to one for uncompressed media). The present invention, in alternative embodiments, includes a simple algorithm that it can execute faster than in real time. Furthermore, the present invention, in alternative embodiments, can detect media identities, irrespective of format, bootleg, editing and other changes to or abuses of the original production. In some embodiments, the present invention can identify movies that are run backwards in time, movies that can be displayed upside down and/or at an angle, and/or movies that can be taken by a camera, and the like.

One purpose of this invention is to identify any form of motional visual media and place the identification information in a master database.

Yet another purpose of this invention is to identify an initially unknown complete media by measuring only a small excerpt from it, followed by a search in the database.

Yet another alternative purpose of this invention is to develop statistical analysis on the false positive or negative of the detection system. That is the probability of identifying media as a specific item when it is in fact not that item, or failing to identify an item that should have been identified using the techniques of this invention.

Another alternative purpose of this invention is to reduce or compress the data so that storage capacity is reduced.

Yet alternative another purpose of this invention is to make economic domestic and professional products that do not have access, or only have intermittent access, to the Internet or other communication method that is widely available for public or professional use that can identify visual media and access permissions associated with each program.

Yet alternative another purpose of the invention is that the copyright and media ownership and other information associated with a particular work are available from the data in the independent device, together with artist and director details and other such information beneficial to the consumer.

Yet alternative another purpose is to be able to update the data in the data base with recent identification of newly released media and to update permission levels of existing information already stored in the data in the independent device, in a secure manner.

Yet alternative another purpose of the invention is to use a robust yet simple algorithm to achieve these objectives that requires a minimum of processing power so that the identification of an unknown or the loading of the master database can run at many times real time in speed.

These and other purposes of the spirit and claims of the invention will be known to anyone skilled in the art.

Embodiments of the present invention provides a system and method to generate unique motional visual media identifiers in the form of a series of numbers, time-codes, and/or characters that are a fraction of the size of a conventional movie, television program, advertisement, computer games software or any form of motional visual media. The present invention enables this without the need for pre-processing or insertion of any code or other form of message in the original media. Further, the present invention operates successfully in detecting any source, including media sources with edits, bootleg, format change, color or black and white, or of very low quality, irrespective of the original form of presentation of the media. One or more embodiments of the present invention does not require a media file to be identical to the original file for it to be unambiguously identified.

One or more embodiments of the present invention detects and calculates identifiers using minimum processor computing power and storage capacity. Optionally, the present invention operates with minimal processing such that identification can occur at high speed or with multiple ratios of real-time play of the original.

The present invention in accordance with some embodiments is directed to further explore the duration of the measurement process to ensure a suitably low probability of false negative and false positive identification. When there is a probability that the identity of a given media is not discovered when it should have been found, then at least one embodiment of the present invention is directed to further explore the duration of the measurement process to ensure a suitably low probability of false negative identification. When there is a probability that the identity of a given media is incorrectly identified as a certain item when in fact it is something else, then at least another embodiment of the present invention is directed to further explore the duration of the measurement process to ensure a suitably low probability of false positive identification.

Alternate embodiments of the present invention provide methods that reduce necessary data to be stored in the master database. The master database is normally remote and can be accessed via the Internet, wireless, telephone or other means of communication. Devices that do not, or only intermittently have means of communication, such as stand alone media players or recorders, are unable to access the identity data and the associated information. Data reduction methods in accordance with one or more embodiments of the present invention allow identity and auxiliary data to be pre-loaded in devices that have a non-volatile memory. Any available memory device in the marketplace can be used with one or more embodiments of the present invention. Alternatively, auxiliary data that is associated with each identity can include certain permissions that respect the wishes of the copyright or owner of the particular work. Optionally, the auxiliary data can include useful information for the consumer, such as information about the media, date of creation, the principal artists and their other current or recent creations, and on the like.

Techniques disclosed in prior art that uses fixed permissions have encountered legal difficulties, such as failure to lift restrictions, as required by law, when copyright of a work that was created some time ago passes into the public domain. Accordingly, one or more embodiments of the present invention overcomes these problems by enabling permissions and new release media identity information to be updated from a special data-track on a new item of media when it is purchased or rented and then played in the machine. In another embodiment of the present invention, data transfer is made in a suitably secure manner. Optionally, local database can be refreshed repeatedly with data as the device is used.

Accordingly, in at least one embodiment, the present invention relates to a system and method to identify motional picture media that comprises the following: The method includes the operative sequential, sequence independent and/or non-sequential steps of: deriving synchronization at picture rate, received picture rate, or time codes therefrom; storing at least one picture; subtracting at least one picture from an adjacent picture; and permitting low pass filter in the two dimensional plane in the picture and remove the high frequency components of the subtracted pictures. The method also includes the steps of detecting the level from the subtracting step caused by sudden changes in the content of adjacent pictures, by triggering a threshold detector; resetting a digital counter to zero; triggering the counter to count pictures between resets; storing the maximum values of the counts prior to reset; processing the counts; and storing a sequence of the derived counts locally with co-synchronized time-codes. The method further includes the steps of loading a master database with measurements from originals or copies of the works to be analyzed; entering copyright, ownership and other data concerning each individual work in the master database; and providing auxiliary information such as promotions, artist and other useful or technical information of any kind. One or more embodiments of the present invention provides a method to identify motional, or visual picture media, of any type, that uses any type of storage, transmission or presentation or method of display by establishing certain first criteria from a reference media, and, by a substantially similar methodology discovering substantially second similar criteria in an initially unknown sample to effect its identity by comparison with the first criteria from the reference media.

Another embodiment of the present invention also provides for storing at least two or more picture; processing color signal components separately before derivation of the count; using a two dimensional low pass or interpolating filter to remove normal movement attributes, but which allows large changes in content between pictures to produce an output; and increasing the number of vector measurements to reduce the probability of false positives and negatives and at the same time reducing the time taken to establish the identity of the media.

One or more embodiments of the present invention further enables a dynamic calculation of the probabilities while the measurements are in progress. Optionally, the present invention stops the measurement process when a suitable false probability ratio is achieved or exceeded, and such ratio can be chosen according to the genre of the content, or for other reasons such as legal or forensic analysis.

Further, the present invention, in alternative embodiments provides that data reduction step reduces the data transferred to the master database. Optionally, the data reduction step of the present invention logs one Byte per vector measurement instead of two or more.

One or more embodiments of the present invention provides a system that uses a forbidden value of zero to indicate that the next two Bytes are one double Byte number, and not two successive single Byte numbers.

One or more embodiments of the present invention further provides that the forbidden value of zero is used to indicate the start of a sequence of double Byte vectors and a second zero Byte to indicate the return to single Byte numbers. Optionally, the present invention provides that two successive zero Bytes are used to indicate that auxiliary data is inserted in the vector file. In alternative embodiments of the present invention, auxiliary data inserted in the vector file includes permissions, means to assist data searches by an unknown vector sequence and other such useful information. In other embodiment of the present invention, the end of the string is indicated by a repeat of the two zero Byte insertion and a return to single Byte vector numbers.

A system in accordance with one or more embodiments of the present invention provides means to divide the measured vector values by two, so that the occurrence of vectors of double Byte values is reduced and thereby further decrease the database storage capacity. The system also includes means that rounds odd numbers alternatively up and down so that the running total count of pictures for the work remains accurate plus or minus one half, rounded to one.

Alternate embodiments of the present invention further provide a method for dividing the vector values by three, four, five or other low number to yet further reduce the number of double Byte numbers required, and to use similar rounding techniques to keep the running count of total pictures accurate plus or minus the low number that is used in the divisor.

In at least one embodiment, the present invention relates to a system that reduces the data in the main database and vectors from measurements on the unknown by taking the difference between successive values that is a differential method. Optionally, the present invention can be combined with and optimized by Hamming methods and look-up tables to give data compression. Optionally, the present invention relates to a system that reduces the data using Zip, 7-Zip or similar algorithms, or other methods currently available, in combination with some or all of the methods in claims 8 through 15.

In an alternate embodiment, the present invention provides a system that is placed in a recording, receiving or playing device such as a ROM drive or consumer hardware device, that is not connected to the Internet or has inconvenient ways of connecting to the Internet, and in non volatile memory be it electronic, disk or other means that has a copy of the parts or all of the master database of identifiers for at least thousands of the most common media programs. Optionally, the present invention provides a database that includes information concerning each media entry, and useful auxiliary data such as, but not limited to copyrights and ownership, permissions to play or copy the media as specified by the owner of the intellectual property and guided by the MPAA and DVD CCA groups and others, promotions and details about the program and artists therein.

The system in accordance with one or more embodiments of the present invention further includes software and/or hardware or both that can enable searches of said local database to establish the identity of the media to be played from any source such as but not limited to an optical disc or pluggable media of any type or technology. Optionally, the present invention provides that auxiliary data is transferred when the identity of the media matches the identity entry in the database, and optionally includes the permission information into action.

In some embodiments of the present invention, the system can update the internal database with the latest information of new releases or media including permissions and auxiliary data from a special data track on a latest media disc that is bought, rented or otherwise acquired. Optionally, the present invention provides that such updates include, but are not limited to new program vector identity files, and all the associated auxiliary data. Alternatively, a system in accordance with one or more embodiments of the present invention can also update the existing database internal to the machine with recent changes to permission and the latest promotions or other corrections to the existing database.

One embodiment of the present invention provides a system and method that can update the internal database by an intermittent connection to the master database via the Internet or, optionally, by wireless or from any suitable media, such as a removable electronic RAM, optical ROM, jump or hard disc drive, or other suitable secure means to effect the transfer.

One embodiment of the present invention provides a system that checks the internal database capacity and automatically allocates space for new information, and if such capacity is not available, that automatically reviews and discards older or less statistically useful data to free up space for the new latest information.

One embodiment of the present invention provides a system that has storage space in the internal database to update the software that runs the database and search facilities or any other associated functions so that improvements to those software programs can replace the existing out of date software programs to improve the operation of the system or supply new facilities. Such software program updates being stored in a specially allocated area of the internal database.

Another embodiment of the present invention provides a method for analyzing video and computer games, TV programs, advertisements, movies, graphics and other sources of visual motion picture content

Another embodiment of the present invention provides a method for analyzing content from disc, a visual camera, or electronically on the Internet, or from any source, whether the analysis is in real time, or faster or slower than real time.

A search system of the content of the master database for a measured vector string of a few Bytes that finds a match for the string even though either some or all of the vector numbers do not match, or that all of the vectors do not match accurately the numbers in the database or vice-versa.

A system that uses fuzzy logic to find a match for a sequence of information that has values that are plus or minus a percentage error from the accurate values that are used as reference in the database, and yet enable a match to be obtained with a high degree of reliability and a very low probability of error, or if necessary continuing the measurement of an excerpt until the user defined accuracy is obtained.

Accordingly, in at least one embodiment, the present invention relates to system and method for the identification of motional media in players and recorders without internet access. The method include the operative sequential, sequence independent and/or non-sequential steps of: deriving at least one of a plurality of first counts, or time codes, of at least one of a plurality of pictures from a first motional picture media, wherein the plurality of pictures is a continuous sequence, and wherein the first counts of the pictures are between shot changes, and storing the at least one of the plurality of pictures in a database. The method also includes the steps of searching the database for a second motional picture media, wherein the second motional picture media is substantially similar to the first motional picture media, comparing the at least one of the plurality of first counts with at least one of a plurality of second counts of at least one of a plurality of pictures from the second motional picture media, and determining whether the at least one of the plurality of first counts is substantially similar to the at least one of the plurality of second counts. The method also includes the steps of retrieving identity data corresponding to the second motional picture media if the at least one of the plurality of first counts is substantially similar to the at least one of the plurality of second counts, and displaying the retrieved identity data corresponding to the second motional picture media. More specifically, the identity data comprises ownership and copyright information.

One or more embodiments of the present invention further comprises the step of retrieving ancillary data associated with identity data corresponding to the second motional picture media. According to some embodiments of the present invention, the ancillary data comprises date of production, date of copyright, artists, director, producer and locations used in the work.

Optionally, the present invention provides that the pictures are a continuous reverse sequence.

One or more embodiments of the present invention provides for the first and second counts of at least one of the plurality of pictures from the first and second motional picture media is from about 1 to about 255 counts. Optionally, the 255 counts corresponds to about 10 seconds between shots.

In one embodiment of the present invention, the first and second counts is assigned zero counts, wherein the zero counts triggers a data reduction.

One or more embodiments of the present invention further comprises the steps of restricting use of second motional picture media if the at least one of the plurality of first counts is not substantially similar to the at least one of the plurality of second counts; retrieving copy control data corresponding to the second motional picture media; and displaying copy control information corresponding to the copy control data. Optionally, the copy control information is at least one of: Copy Never: Pre-Recorded Media, No Home Use, and Copy Never: Trusted Source.

Optionally, the present invention provides that the first and second counts is assigned at least two successive zero counts, wherein the at least two successive zero counts triggers recognition of ancillary data.

In another embodiment of the present invention, the motional media is at least one of: movies, video games, computer games, TV programs, advertisements, and music videos.

In still another embodiment of the invention, a system for identifying motional picture media content is provides. The system includes a programmable storage media comprising a first motional picture media; a media player for deriving from the programmable storage media at least one of a plurality of first counts of at least one of a plurality of pictures from the first motional picture media, wherein the plurality of pictures is a continuous sequence, and wherein the first counts of the pictures are between shot changes; a communication device for communicating with at least one of a plurality of databases comprising at least one of a plurality of motional media; a master database for storing the at least one of the plurality of pictures; a first processor for determining whether the at least one of the plurality of first counts is substantially similar to at least one of a plurality of second counts of at least one of a plurality of pictures from a second motional picture media; a second processor for retrieving identity data corresponding to the second motional picture media if the at least one of the plurality of first counts is substantially similar to the at least one of the plurality of second counts; and a display device associated with the media player for displaying the retrieved identity data corresponding to the second motional picture media.

Optionally, the present invention provides that the programmable storage media is an optical disc or a memory device.

Optionally, the present invention further provides that the media player is capable of reading and/or writing at least one of: CD video (CDV), Digital Versatile Disc (DVD), High-Definition DVD (HD-DVD), Blu-ray discs (BD), and a flash memory device; and the display device is optionally a High-Definition television (HDTV).

In one embodiment of the present invention, the media player analyzes content of the programmable storage media in real time and, optionally, is capable of analyzing content of a motional media stored on a remote database accessible via the Internet.

Each of the above-mentioned one or more embodiments of the present invention can be used by entities to at least one of: (a) ensure management oversight, (b) maintain an “audit quality” history of transactions and other corporate actions, and (c) meet document/electronic records retention and storage requirements, as may required by internal compliance policies and/or external statutory/regulatory frameworks.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The Detailed Description including the description of preferred systems and methods embodying features of the invention will be best understood when read in reference to the accompanying figures wherein:

FIG. 1 is a block diagram of the Media identity system.

FIG. 2 is an illustration of the idealized statistical frequency of vectors.

FIG. 3 is a graphical illustration in logarithmic scale of the false positive probability for a two-hour movie against the number of six second vectors in a sequence.

FIG. 4 is a graphical illustration of time in seconds to identify media against the number of vectors in a sequence for a false positive probability of one in 44.6 billion.

FIG. 5 is a graphical illustration of time in seconds to identify media against the number of vectors in a sequence for a false positive probability of one in 32 million trillion

FIG. 6 is a graphical illustration of time in seconds to identify a movie media against the number of vectors in a sequence for a false positive probability of one in 500,000.

FIG. 7 is a graphical illustration of time in seconds to identify NTSC TV media against the number of vectors in a sequence for a false positive probability of one in 500,000.

FIG. 8 is an illustration showing exemplary methods of storing information in the database.

FIG. 9 illustrates an exemplary method for updating hardware memory.

FIG. 10 is a diagrammatic representation of various system components.

FIG. 11 is a graphical illustration of probability of occurrence of each single shot against the number of pictures in a shot.

### DETAILED DESCRIPTION OF EMBODIMENTS OF THE INVENTION

The following discussion is presented to enable a person skilled in the art to make and use the invention. The general principles described herein may be applied to embodiments and applications other than those detailed below without departing from the spirit and scope of the present invention. The present invention is not intended to be limited to the embodiments shown, but is to be accorded the widest scope consistent with the principles and features disclosed or suggested herein.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

As used throughout the disclosure, the following terms, unless otherwise indicated, shall be understood to have the following meanings. “Picture” or “Frame” refers to a generic term for the file or display of a complete picture in the content. Specific variations may be described and only applied to a given particular scenario.

Picture and Frame are defined as a single picture from a photocopy film that is often used in projection movie theatres or telecine's. Picture and Frame are also defined in interlaced television such as HDTV, NTSC, SECAM or PAL as two successive interlaced fields.

A “Field” refers to an interlaced TV signal in one scan, the next field interlacing with the first to produce a complete picture or frame from them both.

In progressive scan TV or some forms of HDTV, picture is defined as one scan. (In systems without interlace.) This is also the normal way that computer video monitors operate.

A “shot” is the common parlance in the moving pictures business, (Movies and TV), defining a specific time for one (or more) cameras to produce a specific scene. The next shot is of a change in scene.

The concept of “Shot Change”, “Scene Change” or “Cut” is very important for this invention.

“Shot Changes” refers to when one shot or scene is ended, and an edit cuts to the next shot or scene. This may be done by a cut, fast fade, wipe or cross fade. (The latter involves changing the picture between two different scenes, as one is faded out the other is faded in.) For the purpose of this invention a shot change is defined as a cut or edit between two different scenes. In some embodiments, a shot change may be a blank, or a picture with no information, between two different scenes. This is often referred to as “Black” level, colored, grey or “White” level.

Several examples are given below to illustrate the methodology. In these examples the average typical shot change time is taken as six seconds. This would appear to be a reasonable figure, but does not imply a restriction on the invention. For example, it is common in music videos or advertisements to observe many shot changes per second, whereas in a TV news program shots of an announcer may last several tens of seconds. It is the nature and artistic creation of the content that determines the number of pictures in a shot. The value of six seconds is therefore merely used as a typical media illustrative example without implying any restriction on the inventive concepts described herein.

The number of pictures per second also varies widely depending on the technology and method of display. Shot changes start a picture, or time code, counter and the successive total picture counts between shot changes are frequently referred to as numbers or “Vectors” in this application.

Embodiments of the present invention uses technology completely different approach to those fingerprint methods described in the prior art. Instead of finding differences in the vectors from a source, it looks for similarities. The system, in accordance with one or more embodiments of the present invention, classifies signatures into a few thousand, even from a large library, by using a new special perceptually conceived analysis. Consequently, the derivation of the vectors is very robust and has many advantages, not only because they are derived from gross picture parameters, but also because of the signal processing way they are derived, that is an inherently robust methodology in itself.

A method, in accordance with one or more embodiments of the present invention, works by taking a sequence of vectors to effect an identity. While each one in itself is not unique and will occur many thousand times in the database, a sequence of vectors is unique because it arises from the artistic intent of the creator of the work that is not in the least concerned with the derivation of each individual vector nor their relative positions or vector identities in a sequence of vectors.

Another powerful aspect of a method in accordance with one or more embodiments of the present invention is that the probability of occurrence of each vector can be derived, from its frequency of occurrence and the total number of occurrences of every vector in the database. Using a simple look-up table, each and every possible vector has associated with it a certain probability of occurrence resulting from the statistics of the measurements derived from a large library. Consequently, a running calculation of the overall probability of false positive, negative or collision can be derived during the measurement process for the unknown clip so measurements can be stopped when the wanted probability is reached or exceeded. This means that the measurement times are minimized and are of just sufficiently adequate time to ensure the result meets pre-specified levels of confidence.

Embodiments of the present invention are directed to digital methods for analysis, should an analog source be used then an analog to digital converter should generally be deployed to convert the information to a digital format. (Although analog analysis methods could be used with a digital or analog counter or time code clock). Alternate embodiments of the present invention can be implemented in analog by using analog circuits.

Embodiments of the present invention operates by deriving a continuous sequence or set of numbers that are the counts of the pictures or the number of fractional second times between shot changes.

Embodiments of the present invention operates by deriving a discontinuous sequence or set of numbers that are the counts of the pictures or the number of fractional second times between shot changes.

The derived set of vectors (representing the picture count between shots) is compared to the original media in a database that has a similar or original representative set of aforesaid numbers. In one or more embodiments of the present invention, vectors are fractional second times between shot changes. Related to these number sequences in the database, are the ownership and copyright information together with the date of production, and other ancillary data included by the owner. In one or more embodiments of the present invention, auxiliary information may be stored in a separate database. A pointer may be used from the first database to the second database to access the appropriate information. There are many international standards determining the essential data and format of such information. It is not the purpose of this invention to discuss these aspects, as they are well documented elsewhere, but rather to ensure that the identity of the given media is found to correspond to the identity of the original reference work.

The database includes vectors representing the identity of the original work. These vectors are derived using the same method used to identify the work in the field, the Internet, or from any source under test or scrutiny.

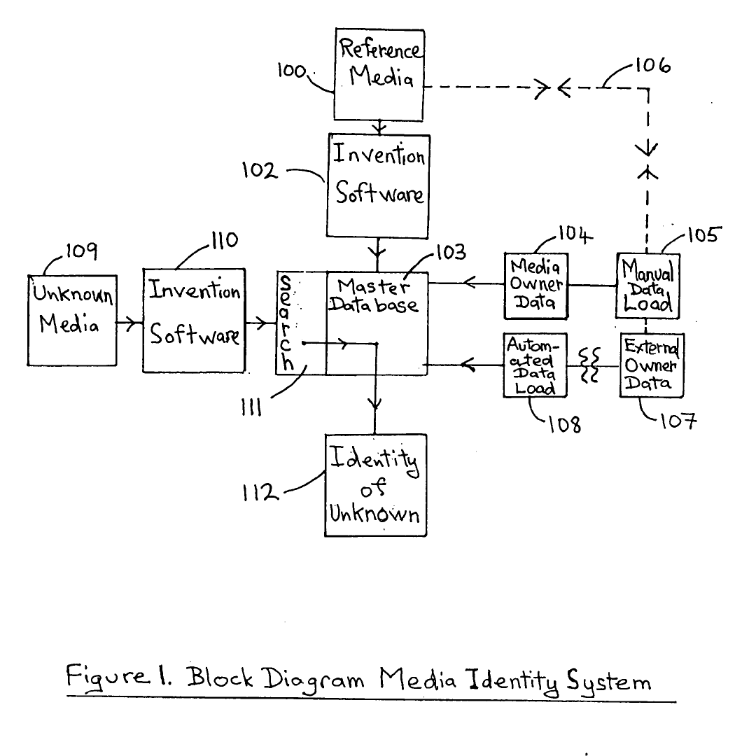

Referring now to the drawing, and more particularly to FIG. 1, there is shown a motion identity system, which incorporates the preferred embodiments of the present invention. Motion identity system in FIG. 1 includes reference media 100, invention software 102 and 110, master database 103, media owner data 104, manual data load 105, external owner data 107, automated data load 108, and unknown media 109.

Motion identity system in FIG. 1 searches and compares, in the database 103, vectors resulting from the test of an unknown program, and establishes the identity of the work when a match of the sequence is obtained. Reference media 100, either the original media or a copy of the media, derives the identity vectors 106 using invention software 102, and master database 103 stores derived vectors. Motion identity system in FIG. 1 receives ownership and other data associated with identity vectors 106, from manual data load 105. Motion identity system, according to one or more embodiments of the present invention, receives ownership and other data associated with that work 106 from an automated external source 107. Media owner's data 104, or automated data 108, are loaded into master database 103 and associated with the media vectors identifying the work 100.

In one or more embodiments of the present invention, when a master or copy of the original is analyzed for the database, several parallel versions are simultaneously logged. In one embodiment of the present invention, the analysis is logged as frame count. In another embodiment of the present invention, the analysis is logged as seconds count. In yet another embodiment of the present invention, the analysis is logged as differential speed count to take into account the potential differences in future analysis of clips at varying speed. Speed variations can be regularly or intermittently dropped or repeated Frames or pictures, so that by a parallel search method the excerpt is still rapidly identified because of the fundamental methodology of this invention. In other embodiments of the present invention, auxiliary data (e.g., artist etc.) can be static in a separate database. When a search is performed, a pointer is employed to this relatively static database when the ID is found to obtain the ancillary data. In yet another embodiment of the present invention, analysis software is the same as that used to load the database.

When an unknown file is found, invention software 110 (same as invention software 102) processes the unknown file for a limited time, and passes the resulting vectors to search component 111 of master database 103. When a match for the vectors is obtained, identity information associated with the unknown file is displayed, transmitted or printed 112. In one or more embodiments of the present invention, software 110, used to derive the identity vectors from an initially unknown excerpt of a work, is not be similar to software 102 that is used to derive and load the vectors in the master database. In one example, reasons for differences between software 110 and 102 include a need to make the analysis software very fast, resulting in the use of “Short cuts” that could also lessen its accuracy. In another example, reasons for differences between software 110 and 102 include a need to make the master database software more elaborate to supply additional analysis, details or facilities to assist fast searches. Optionally, the reverse may be true in some applications. One or more embodiments of the present invention robustly derive measurable vectors when any compatible software is used for any end application.

In order to ensure that there is a sufficiently low probability of a false negative or false positive for the identification of a particular program, motion identity system according to an embodiment of the present invention estimates the probabilities of whether identification of a particular program would occur. Motion identity system according to another embodiment of the present invention estimates the probabilities of whether identification of a particular program would occur using a theoretical model based on the numbers for the vector measurements themselves. Motion identity system according to yet another embodiment of the present invention estimates the probabilities of whether identification of a particular program would occur based on the probability of a number based on the frequency of numbers that arise in practice.

Motion identity system, as shown in FIG. 1, will first analyze the theoretical values. The number of pictures in a scene between shot changes is a random number that arises as a result of the artistic and creative process. The minimum number that can arise is one—it is possible to display a given scene for one frame. Zero is a forbidden number since, by definition, there cannot be zero pictures between a shot or scene change. On the other hand, the maximum number can theoretically be of any value. In one embodiment of the present invention a two byte or sixteen bit counter is used as the principal picture counter as previously described. Therefore, motion identity system in FIG. 1 can count up to 65,535 pictures between shot changes. This corresponds to 45 minutes and 31 seconds at the movie 24 picture rate, 36 minutes and 25 seconds at about the NTSC 30 picture rate, and 43 minutes and 41 seconds at the 25 picture PAL rate. It is extremely unlikely that a single scene would last long. When a single scene lasts for a longer duration, a larger number would be rounded down to the maximum count of the 16 bit counter.

It has been found that the average duration of a shot change varies not only with the content but falls into classes that correspond to the genre of the content. For example, music videos and advertisements have frequent shot changes, sometimes as often as one, two or three a second on average. Action movies have periods of rapid shot changes interspersed with longer durations between shots. On the other hand, period plays and documentaries tend to have scenes that last for many seconds, sometimes a few tens of seconds.

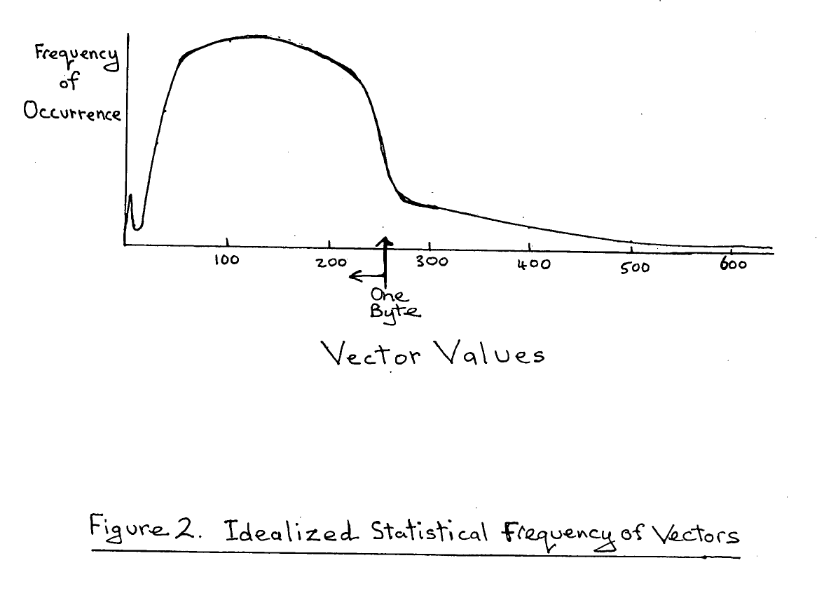

FIG. 2 shows the idealized outline of a typical statistical histogram of the distribution or frequency of occurrence of the vectors for a typical movie. The vector values are defined by integers, which may be absent or may occur several times in a given work. A small peak at low vector values is due to either rapid shot changes or rapid movements of the pictures in the work. A broad peak, from about two seconds to about ten seconds in the curve, corresponds to about fifty to two hundred and fifty pictures between shots. FIG. 2 also illustrates that the outline graph includes a long “tail,” where one expects some shots to last longer than ten, twenty, thirty seconds or more. The maximum value of a one Byte count of 255 is shown on the y-axis. The curve, shown in FIG. 2, is not Gaussian or “Bell” shaped and, thus, normal statistical methods that apply to Gaussian curves cannot be used in the computation of probabilities of vector occurrence.

Nevertheless, it is useful to develop the general equation for calculating an estimate of the probability that can arise for a sequence of vectors. For a given program, the following parameters are defined.

| | |
|---|---|
| Let the total duration of the work be: | t seconds |
| Let the duration of a measured vector be: | x seconds |
| Let the number of vectors in a chosen sequence be: | y (an integer) |
| Therefore the total time for a vector sequence is: | xy seconds |
| Therefore the total number of vector sequences | t/xy |
| in the work is: | |
| Let the number of pictures per second be: | n (1/seconds) |
| Therefore the number of pictures per vector is: | nx |
| Let the wanted probability be: | P |

Initially, it is assumed that a vector has a probability of occurrence that is proportional to the number of pictures it represents, such that the total probability of its appearance is equal to its measured vector number. The probability of two occurrences is number of pictures per vector for one vector multiplied by number of pictures per vector for second vector, of three occurrences is product of three values of number of pictures per vector,and so on. In other words, the probability represents the numbers multiplied together. However, because of the nature of the creative process, each number can be used repeatedly and is not excluded if already used. So, for example, if the number of pictures per vector is nx for the first number, then that number nx can be repeated throughout the work. Therefore, this analysis assumes a typical average value for the vector count to estimate the total possibilities that will be obtained in a sequence of y vectors. Therefore, initially let:
P=(nx)^{y}

In some embodiments of the present invention, this quantity has a chance of occurring throughout the work, which is given by the number of possible vector sequences in the media in question (t/xy). Therefore, the probability of occurrence becomes number of pictures per vector (nx) divided by the number of attempts to achieve this sequence (t/xy). As a result, the final probability estimate for a given work is given by:

$$P = \frac{{( n x )}^{y}}{( t / x y )}$$

This is rearranged and simplified as follows:

$$P = \frac{x {y ( n x )}^{y}}{t} \\ \frac{P t}{y} = {x ( n x )}^{y} \\ \frac{{( P t )}^{1 / y}}{{y}^{1 / y}} = {x}^{1 / y} ( n x )$$

$$\frac{{( P t )}^{1 / y}}{n \cdot {y}^{1 / y}} = {( x )}^{y + 1 / y}$$

Finally we have:

$$\frac{P t}{{n}^{y} \cdot y} = {x}^{( y + 1 )}$$

For a given probability (P), with total media duration of t seconds and number of pictures per second (n), number of vectors in a sequence (y) can be tabulated against the duration of each vector in seconds (x) to achieve the desired probability.

A more complete understanding of the present invention can be obtained by referring to the following illustrative examples of the practice of the invention, which examples are not intended, however, to be unduly limitative of the invention.

### EXAMPLE 1

In the following example, a movie is chosen and tables of values are derived for various scenarios. For the purpose of this analysis, typical average scene and movie durations are used to illustrate the methodology and calculate probabilities. For the sake of illustration, example scenes are chosen that last exactly six seconds, or 144 pictures, in a movie that is exactly two hours or 7,200 seconds long. Therefore, there are 1,200 shot changes in this movie with a total of 172,800 pictures.

The parameters for the movie are as follows:

Total movie duration, t=7,200 seconds (2 hours)

Measured Vector duration, x=6 seconds

Number of vectors in sequence, y=4, 5, 6 . . . 12.

Number of pictures/second, n=24

Table 1 shows the probability of false positives versus the number of vectors measured in a sequence, for an average of six seconds per shot of 144 Pictures.

TABLE 1

| Number of | Total Number | Vector | False Positive | Real-Time to |
|---|---|---|---|---|
| Vectors in | of Pictures In | Sequences | Probability | Identify Movie |
| Sequence | Sequence | per Movie | One in . . . | Seconds |
| 4 | 576 | 300 | 1.43 × 10⁶ | 24 |
| 5 | 720 | 240 | 2.58 × 10⁸ | 30 |
| 6 | 864 | 200 | 4.46 × 10¹⁰ | 36 |
| 7 | 1,008 | 171 | 7.51 × 10¹² | 42 |
| 8 | 1,152 | 150 | 1.23 × 10¹⁵ | 48 |
| 9 | 1,296 | 133 | 2.00 × 10¹⁷ | 54 |
| 10 | 1,440 | 120 | 3.19 × 10¹⁹ | 60 |
| 11 | 1,584 | 109 | 5.06 × 10²¹ | 66 |
| 12 | 1,728 | 100 | 7.95 × 10²³ | 72 |

From Table 1, it can be seen that with measurements of only six successive vectors there is a probability of a false positive of one in 44.6 billion. The media would then be identified in about 36 seconds (plus/minus). Since there are fewer than one million full-length movies and TV media, the probability of misidentifying at least one of them is less than one in about 50,000.

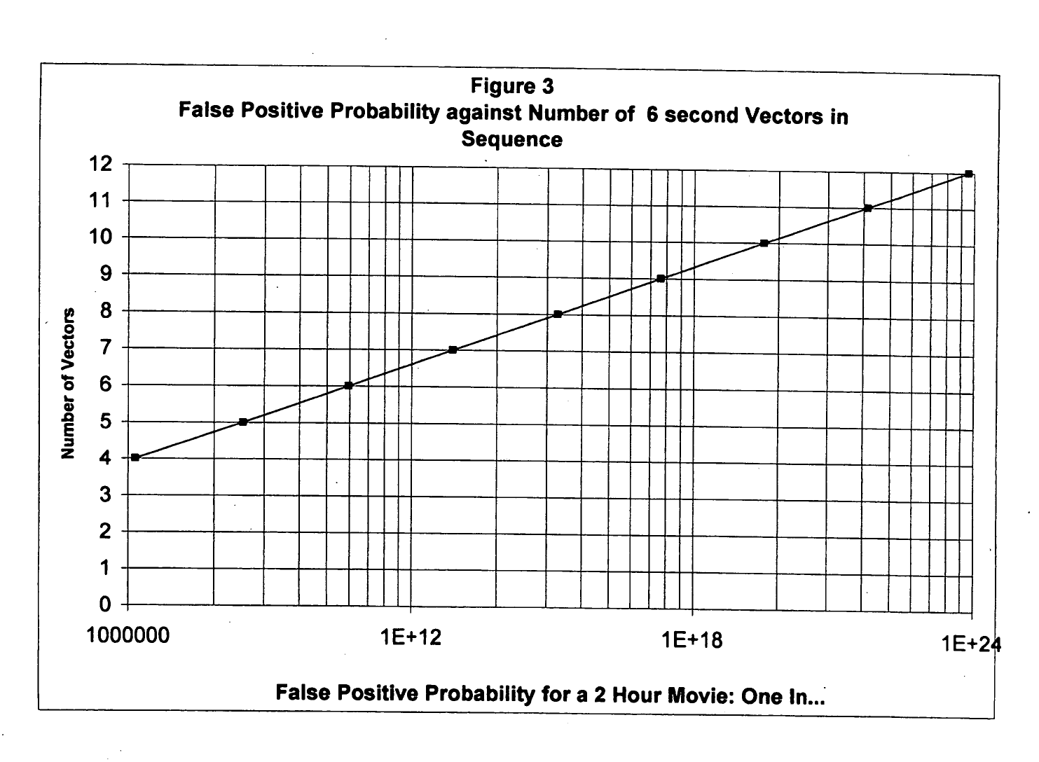

FIG. 3 shows a graph of the results in which the number of a sequence of vectors is plotted against the probability of a false positive on a logarithmic scale.

Next, the probability of one in 44.6 billion is fixed and a table of values, in which the vector duration and number of vectors in a sequence are variables, is obtained to investigate a more practical situation and show their influence on identity times. Apart from the vectors, the parameters for the movie remain unchanged. These are shown in Table 2.

TABLE 2

| | Time | | | | Total |
|---|---|---|---|---|---|
| | for each | | Pictures | | time for |
| | vector | Number of | in each | Total | sequence |
| | or shot- | Vector | vector | number of | (Real Time |
| Number of | change | sequences | (Rounded | pictures in | to identify |
| Vectors in | (Rounded) | in | to whole | vector | movie) |
| Sequence | Seconds | movie | number) | sequence | Seconds |
| 6 | 6.00 | 200 | 144 | 864 | 36.0 |
| 7 | 3.16 | 325 | 76 | 532 | 22.1 |
| 8 | 1.93 | 467 | 46 | 368 | 15.3 |
| 9 | 1.30 | 651 | 31 | 280 | 11.7 |
| 10 | 0.94 | 808 | 23 | 226 | 9.4 |
| 12 | 0.574 | 1045 | 14 | 165 | 6.9 |
| 15 | 0.346 | 1387 | 8 | 125 | 5.2 |
| 18 | 0.245 | 1630 | 6 | 106 | 4.4 |
| 24 | 0.159 | 1893 | 4 | 91 | 3.8 |

Table 2 illustrates as shot changes reduce in time, more vectors must be measured to achieve the same probability of false identification. Further, the time to establish identification is also reduced. Table 2 suggests that if each shot change is slight under one second, then 10 vectors need to be measured and the movie can be identified in about 9.4 seconds with a statistical false positive probability of one in 44.6 billion.

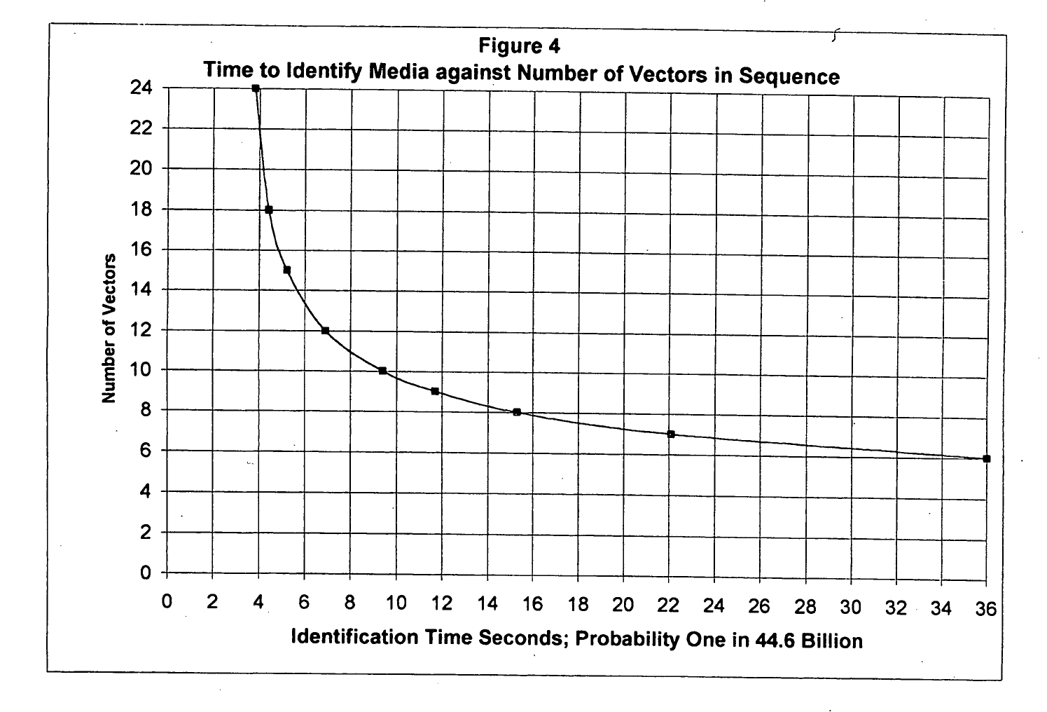

FIG. 4 graphs the results of the number of measured vectors against the time to identify the movie taken from table two. FIG. 4 shows that as the vector count increases in the region of about 15 to 24 the rate of change for improved identification reduces. Also, at high identification times, there is a slower rate of change in the curve with vector count. Optimum detection occurs when a tangent to the slope of the graph is at its maximum rate of change or at about 45 degrees to the axes. In FIG. 4, this optimum occurs when about 11 to 13 measurements are made that correspond to about 6 to 8 seconds for the time to identify the movie.

### EXAMPLE 2

In the following example, the false positive probability is increased from on in 44.6 billion to about one in 32 million trillion (1 in 32×10¹⁸), and the results are shown in Table 3.

TABLE 3

| | Time for | | | | Total |
|---|---|---|---|---|---|
| | each | | Pictures | | Time for |
| | Vector | | in each | Total | Sequence |
| | or Shot- | Number of | Vector | Number of | (Real Time |
| Number of | change | Vector | (Rounded | Pictures in | to identify |
| Vectors in | (Rounded) | Sequences | to Whole | Vector | movie) |
| Sequence | Seconds | in movie | Number) | Sequence | Seconds |
| 6 | 110.5 | 10.9 | 2,651 | 15,906 | 663 |
| 7 | 40.45 | 25.4 | 971 | 6,795 | 283 |
| 8 | 18.56 | 48.5 | 445 | 3,563 | 148 |
| 9 | 9.97 | 80.3 | 239 | 2,152 | 89.7 |
| 10 | 6.00 | 120 | 144 | 1,440 | 60.0 |
| 11 | 3.93 | 166 | 94 | 1,039 | 43.3 |
| 12 | 2.76 | 218 | 66 | 793 | 33.1 |
| 13 | 2.03 | 273 | 49 | 633 | 26.4 |
| 14 | 1.56 | 330 | 37 | 523 | 21.8 |
| 15 | 1.24 | 388 | 29 | 446 | 18.6 |
| 18 | 0.718 | 557 | 17 | 310 | 12.9 |
| 21 | 0.483 | 709 | 12 | 244 | 10.2 |
| 24 | 0.358 | 837 | 8.6 | 206 | 8.60 |

In order to obtain the extremely small value of false positives shown in Table 3, the number of measured vectors must naturally increase. For example, from Table 3, measuring 11 vectors whose average duration is slightly less than 4 seconds will identify the movie in about 43 seconds with a false positive probability of one in 32 million trillion.

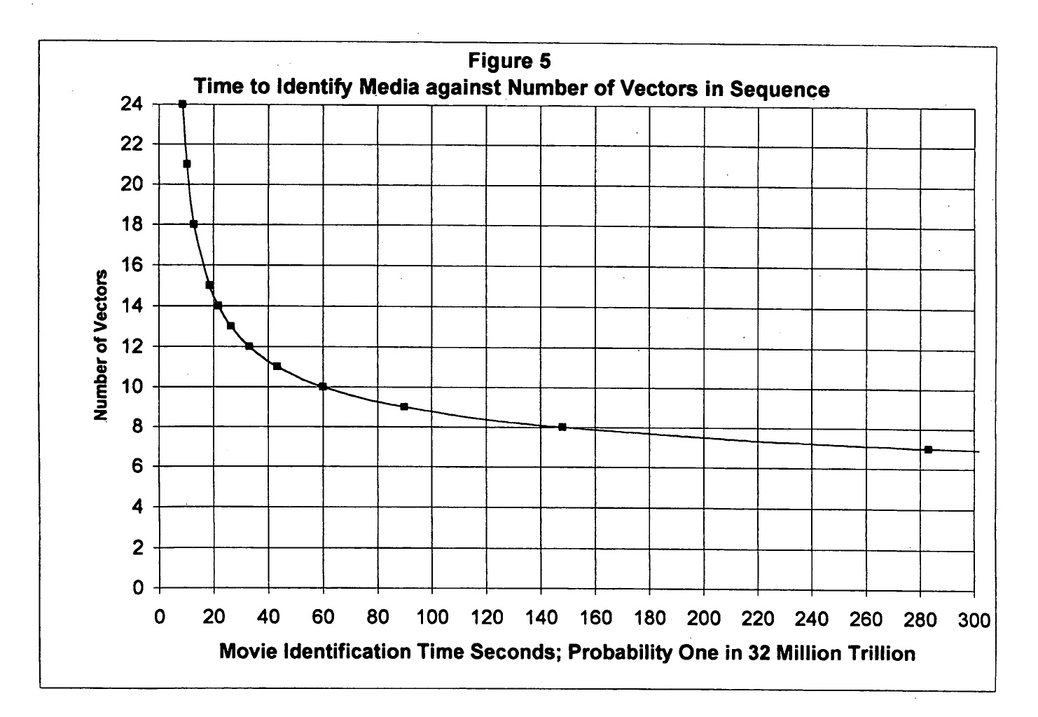

The probability of misidentifying any of the less than one million full-length motional media ever created will then be less than one in 32 trillion. (32'10¹²). The graph of the results is shown in FIG. 5. FIG. 5 has similar characteristics to FIG. 4, except that at the optimum point is when the number of measurements is about 11 to 14 and the corresponding detection times are about 42 to 20 seconds respectively.

### EXAMPLE 3

In the following example, illustrating the above approach to statistical estimation, the other extreme is used with a low value of false positive probability of one in 500,000. Table 4 illustrates false positives of one in 500,000 movie program for a movie with the same parameters as above including the picture rate (n) of 24 per second. Table 5 illustrates false positives of one in 500,000 for a NTSC television program of 2 hours duration but with 30 pictures per second, all other parameters being the same as the previous movie examples.

TABLE 4

| | Time for each | | Pictures in | Total | Total Time for |
|---|---|---|---|---|---|
| | Vector or shot- | Number of | each Vector | Number of | Sequence (Real |
| Number of | change | Vector | (Rounded to | pictures in | Time to identify |
| Vectors in | (Rounded) | Sequences in | whole | Vector | Program) |
| Sequence | Seconds | Program | Number) | Sequence | Seconds |
| 3 | 17.2 | 139.8 | 412 | 1,236 | 51.5 |
| 4 | 4.86 | 370.3 | 117 | 467 | 19.4 |
| 5 | 2.12 | 679.7 | 51 | 254 | 10.6 |
| 6 | 1.18 | 1,019 | 28 | 170 | 7.07 |
| 7 | 0.761 | 1,352 | 18 | 128 | 5.32 |
| 8 | 0.543 | 1,658 | 13 | 104 | 4.34 |
| 9 | 0.415 | 1,928 | 10 | 90 | 3.73 |
| 10 | 0.334 | 2,159 | 8 | 80 | 3.34 |

TABLE 5

| | Time for each | | Pictures in | Total | |
|---|---|---|---|---|---|
| Number of | Vector or | Number of | Each Vector | Number of | Total Time for |
| Measured | Shot-change | Vector | (Rounded to | Pictures in | Sequence (Real |
| Vectors in | (Rounded) | Sequences in | whole | Vector | Time to identify |
| Sequence | Seconds | Program | Number) | Sequence | Program) Seconds |
| 3 | 14.5 | 165.3 | 436 | 1,307 | 43.6 |
| 4 | 4.07 | 442.7 | 122 | 488 | 16.3 |
| 5 | 1.76 | 818.6 | 53 | 264 | 8.80 |
| 6 | 0.973 | 1,234 | 29 | 175 | 5.84 |
| 7 | 0.626 | 1,644 | 19 | 131 | 4.38 |
| 8 | 0.445 | 2,022 | 13 | 107 | 3.56 |
| 9 | 0.339 | 2,357 | 10 | 92 | 3.06 |
| 10 | 0.272 | 2,644 | 8 | 82 | 2.72 |

At these probabilities, one can consider them as “rough guesses” of the identities. Further, there is less than an even chance of being incorrect if all the full-length media ever created are under review. Further, the identity times are reduced to a few seconds.

Tables 4 and 5 suggest that if five vectors are measured in which shot changes occur about every two seconds, slightly more for movies and slightly less for television, then identity can be established in about 10.6 and 8.8 seconds respectively. This would be a typical practical scenario because of the frequent shot change occurrence in media. This approximate identity would speed up detection because it can be used to jump to the approximate indexed position for the identity in the database. By measuring a few more vectors in the unknown sample under scrutiny, the confidence of the result will rapidly increase until a match with a very high certainty is obtained, as shown in Tables 1-3.

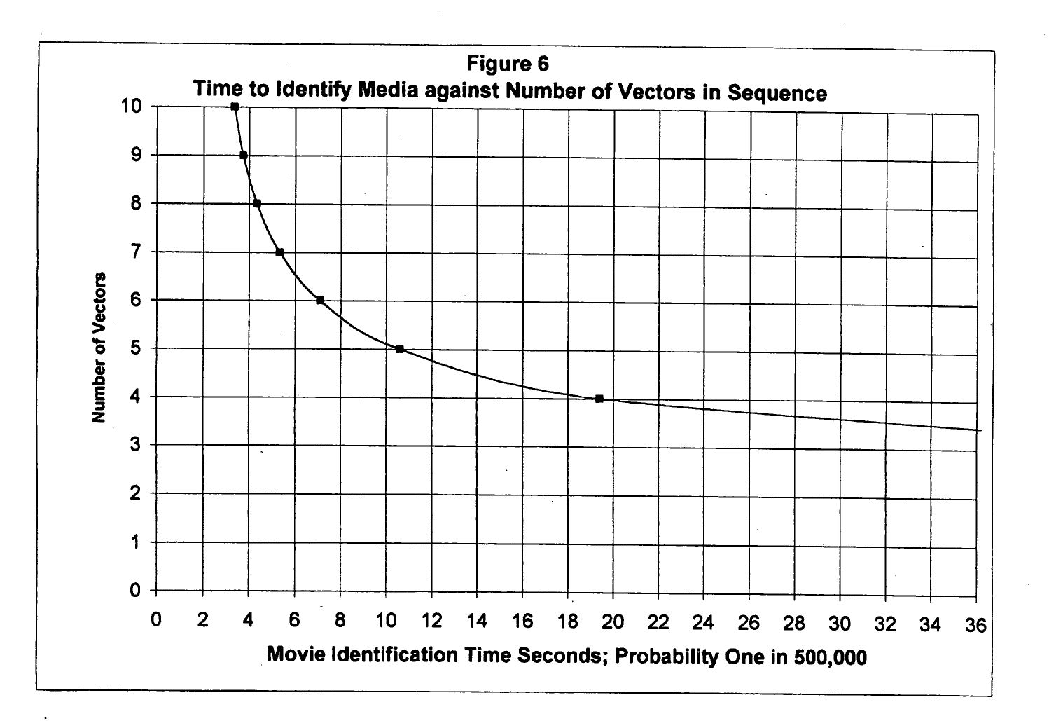

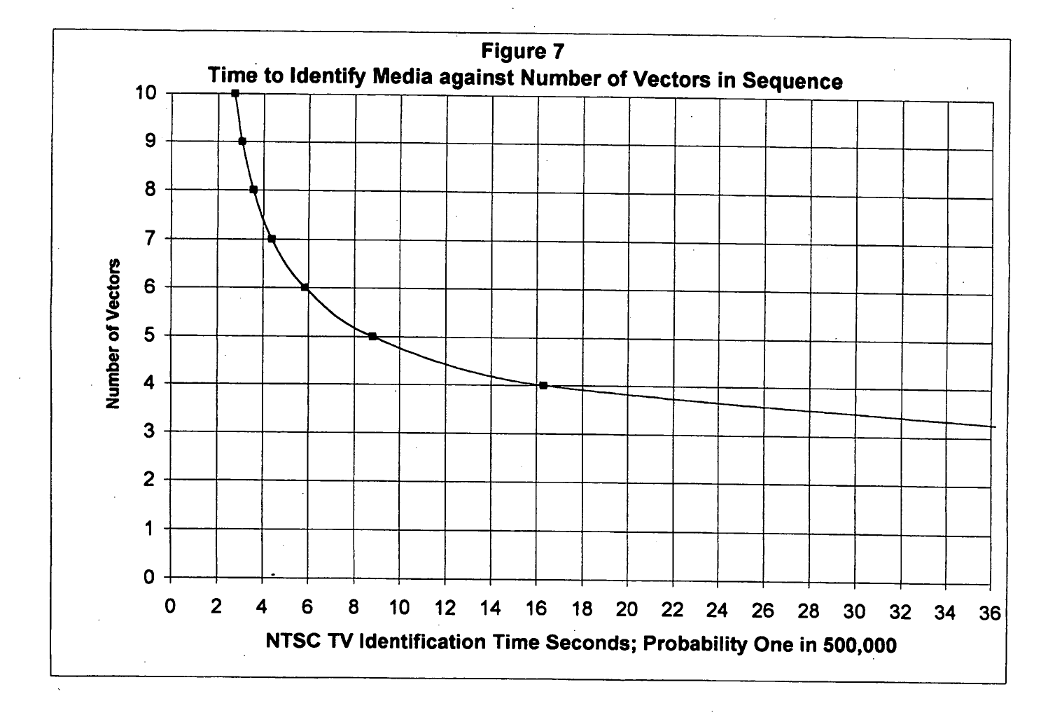

FIGS. 6 and 7, which are graphical illustrations of Tables 4 and 5 respectively, show that most efficient points are when about six vectors are acquired that identify in about six seconds.

One embodiment of the present invention can be used to obtain a good estimate of the identity of a two-hour program, using six vectors or six to about twelve Bytes, from an original MPEG-2 encoded program that would be approximately 5 to 7 Giga-Bytes. In another embodiment of the present invention, there is an even chance of achieving the identity of one two-hour program with a false positive probability of one in 500,000. In yet another embodiment of the present invention, less than 12 Bytes are required to have an evens chance of finding a specific file from approximately 2.5 Peta-Bytes (2.5×10¹⁵ Bytes) of compressed information. The 12 Bytes are derived from anywhere within one 5 Giga-Byte file. It has been shown that measurement of a few more vectors will reduce the probability of errors in the identity from an evens chance to one part in millions even if all 500,000 files are in the master database.

Tables 1-5 also confirm that erroneous vectors can be ignored in the data search. In one embodiment of the present invention, erroneous vectors mean measurements are made on a lower quality or manipulated source, and that the shot change detector produces measurements that are not always the same as the original that is in the database. In another embodiment of the present invention, erroneous vectors mean measurements that are made on a lower quality or manipulated source so that the shot change detector produces measurements that are not always the same as the current values in the database, further suggesting a poor or compromised copy of the original. At least, initially, meaning that a poor copy may be the only one available at the time of loading the database, but if a better copy is obtained later then the database entry can be updated to give higher accuracy.

All the above estimates of probability are predicated upon a typical length of program and with typical durations of time between shot changes, and assume that a given typical vector has the same value repeatedly. This represents a good approximation since the vector durations are of those that occur regularly on average in typical media programs. However, in practice successive vectors will generally be of different values. A curve of the probability of each vector value plotted against the frequency of occurrence for many movies can be drawn. As previously mentioned, the curve does not have a Gaussian or normal distribution. It is found that vectors between values of about 50 to 250 have approximately equal probability; there is a smaller peak at low values and a rather long “tail” of numbers occurring less frequently of values above 250. The most frequent occurrences are in the range therefore between about two seconds to about ten seconds. The low value sub-peak is from about one eighth to about three quarters second depending on content.

In one embodiment of the present invention, estimation of false positives can be achieved by considering that the probabilities of vector values between 50 and 250 (a range of 200 values) are about equal. The probability of occurrence for any given vector will be approximately one in 200, ignoring the less frequent numbers below 50 and above 250. Thus, measurement of seven vectors will give an approximate probability of 200 to the seventh power or 1.28×10¹⁶ (12.8 thousand Trillion).

These values correspond to the values previously calculated, for example in Table 1 where it corresponds to measurements of between eight to nine vectors. These corresponding tabulated values in Table 1 represents a different approach to the statistical estimation of the probability of false positive identification. In practice, the curve discussed above will differ according to a particular program, but might have some similarity to other media of the same genre. In spite of this, each actual program will be different and will have its own relationship to the probability of false positive identification. However, if the number is sufficiently small then the exact number is not of concern since it is the relationship that a particular program has in relation to all other programs that is important.

In another embodiment of the present invention, the probability of a false positive can be calculated “on the fly” while the unknown is being measured using an adaptation of the formula that was developed earlier in this application. Since initially the duration (t) of the unknown work is not known, an approximate value can be used, for example one hour or t=3,600 seconds. As soon as a likely match is obtained, a more correct value for t can be used in the formula derived from the database value, and then measurements continue until the probability P is equal to or greater than the wanted value. By this means, a dynamic way of both measurement and search can be used.

In some embodiments of the present invention, the accuracy of search can be customized according to the wishes of the organization that requires the identity of initially unknown works. For example, movie houses engaged in marketing statistics might want to be very certain of correct identities, and similarly for legal purposes, but some consumers may not be so interested in these levels of accuracy. This is a very important matter if there are thousands of search requests to the database per second, since the ability of a given database to handle the traffic depends, amongst several factors, on the ability to complete searches as rapidly as possible and one strategy to achieve this to decrease the search time for each request. By employing a running calculation on each of the measurement requests, the search can be terminated as soon as the required accuracy is achieved, thereby reducing unnecessary continuation of the given search.

In order to calculate the probability density for a given work, the formula derived earlier must be modified since each vector can have a different value. For example, each vector can have any value for x and the duration in seconds between shot changes. If we set successive vectors to have values as follows:
(x₁), (x₂), . . . (x_{y})
Then we can create
x^{y}=(x₁)·(x₂)·(x₃) . . . (x_{y})

An approximate way of estimating the probability can be derived using the simple initial formula:
P=(nx)^{y}

By substitution for x^{y} and inserting n, we have:
P=(nx₁)·(nx₂)·(nx₃) . . . (nx_{y})

This can be very simply calculated dynamically as each successive measurement of x is made it is multiplied by n and then by the multiplicand from the previous measurements.

For a more accurate result, the probability formula developed earlier must be applied:

$$\frac{P t}{{n}^{y} \cdot y} = {x}^{( y + 1 )}$$

Rearranging and multiplying the powers by y/(y+1) gives:

$${( \frac{P t}{{n}^{y} \cdot y} )}^{\frac{y}{y + 1}} = {x}^{y}$$

S u̅b̅s̅t̅i̅tuting for x^{y} gives:

$${( \frac{P t}{{n}^{y} \cdot y} )}^{\frac{y}{y + 1}} = ( {x}_{1} ) \cdot ( {x}_{2} ) \cdot ( {x}_{3} ) … ( {x}_{y} )$$

The above formula enables a running calculation of a probability estimate with P as the variable. As each successive vector is measured, y is incremented by one and the corresponding measured value for x is successively placed in the calculation. Successive increasing values for P can then be obtained and the measurement process can be stopped when the desired value equals or exceeds P. It should be noted that this is still an estimate of the probability of false positives. A correct value can be obtained if the values for x were actual probabilities rather than the numerical vector value. If the value of each vector's probability is set to (p₁) etc., and the total to pₜₒₜ, which replaces x^{y}, then ideally it should be substituted as follows:
pₜₒₜ=(P₁)·(p₂)·(p₃) . . . (p_{y})

However, an actual probability value for each measurement is an imponderable, until statistically significant results are obtained by measurements on a wide range of actual media. This is because it is dependent not only on the spectrum of probabilities for the given media but also for those of all media that are available and whose identities could be mistakenly chosen instead of the correct one. Therefore, using the values of x employs the best estimate. Since the probability of a false positive is one part in P, and P rapidly grows to a very large number as successive vectors are measured this approach is sufficiently accurate, very practical and is simple to calculate dynamically.

Since the probability for each signature is known, a sequence of vectors, P, Q, R, S . . . Z can be used to form a running calculation of the probability by multiplying each successive measured vector to the accumulated multiplicand of the previous vectors.

### EXAMPLE 4

The following example illustrates the method with a typical statistically average example that uses actual measurements from an excerpt from the movie, “History of Violence”. Table 6 illustrates the actual signature sequence with probabilities and timings.

TABLE 6

| | | Look-up | | | One | |
|---|---|---|---|---|---|---|
| | | Individual | Accumulated | Inverse of | Million | Length of |
| Sequence | Look-up | Signature | Total | Total | Programs | Unknown |
| of | Signature | Probability | Probability | Probability | in Library | that is |
| Measured | Reference | of | of Sequence | One Part | Inverse | Analyzed |
| Signatures | Integer | Occurrence | P × Q × R . . . | in . . . | Probability | in Seconds |
| P | 47 | 0.006203 | 0.006203 | 158.6 | 1/6305 | 1.568 |
| Q | 65 | 0.006837 | 0.00004241 | 23,579 | 1/42.4 | 3.737 |
| R | 29 | 0.002452 | 1.0399E−7 | 9.62E+6 | 9.62 | 4.705 |
| S | 197 | 0.001571 | 1.6337E−10 | 6.12E+9 | 6,120 | 11.28 |
| T | 75 | 0.006164 | 1.007E−12 | 9.93E+11 | 9.93E+5 | 13.78 |
| U | 99 | 0.004407 | 4.438E−15 | 2.25E+14 | 2.25E+8 | 17.07 |
| V | 44 | 0.005497 | 2.439E−17 | 4.10E+16 | 4.1E+10 | 18.55 |
| W | 36 | 0.004498 | 1.097E−19 | 9.11E+18 | 9.1E+12 | 19.75 |
| X | 61 | 0.006834 | 7.499E−22 | 1.33E+21 | 1.3E+15 | 21.79 |
| Y | 78 | 0.005695 | 4.271E−24 | 2.34E+23 | 2.3E+17 | 24.41 |
| Z | 103 | 0.004283 | 1.829E−26 | 5.47E+25 | 5.4E+19 | 27.85 |

Please note that the probabilities in the column with one million programs in the library are approximate since all the probabilities herein illustrated are derived from a relatively small data set. In practice these will have to be calculated separately given the equations described in this application, when all the actual values are established from the universe of values for every single vector. Alternatively, dividing the calculated probabilities by the number of program hours in the data base times five hundred can also be used. (Since very approximately there are a little more but about 500 shots per hour). Also, for the purpose of illustration the last column in seconds does not illustrate the absolute times of occurrence of this clip in relation to the master. Only times are shown relative to the start of the measurement process for this particular clip. This was done for illustrative reasons of clarity.

For the purposes of illustration of the technology, it can be seen that the very approximate probability of a correct identification with a million programs in the library is 225 million to one after measurement of about 17 seconds of the unknown, and 9 trillion to one after about 20 seconds. Also, a rough guess of the identification with 10 to one odds on of being correct can be made after about 5 seconds. This information assists in “Fast” database searches.

Table 6 further illustrates that the accuracy of the measurement can be at any level that is required by the end application. More accuracy requires analysis of a larger amount of the unknown. Also it can be seen that running calculations can arrange for the analysis to end when the desired confidence interval is reached, thus saving unnecessary measurement effort and time. Even if in practice final values turn out to be very different from those shown here, the point of this illustration is show the basic concept of how the invention can be made to work in an embodiment.

While Example 4 is a typical example from one movie, in practice because of artistic intent, signature vector sequences are random and can vary widely in duration, (Both shorter and longer), for a wanted probability. This example is a typical average example from the statistics that have been obtained so far. It is expected that the shape and amplitude of the probability curve will largely be the same, but may contain major differences of detail, as more works are analyzed.

The results shown in Example 4 assume that each vector is measured and allocated correctly in the look-up table. If some of the allocations are incorrect due to picture quality or other reasons, then additional measurements will be needed to give the identification probabilities shown in the Table 6. Generally, one wrong vector requires one extra measurement. In fact, statistically it is less than this since a fuzzy search can help to compensate for incorrectly measured signatures.

In other embodiments of the present invention, for every known motional media measured, the frequency of occurrence of each and every vector would be known in addition to the total number of vectors that exists. With this information, an accurate probability of occurrence for every single vector could be calculated using a look-up table that relates the measured vector value to its corresponding probability of occurrence. These values would then be used in the above equations. In practice, this extreme methodology is not necessary because the measurement of a few thousand programs of widely differing genres would give a statistical result that is adequately accurate for the reasons discussed above.

Further, the values for false negatives would follow similar reasoning and, for present purposes, can be taken to be equivalent to the values for false positives.

Master database 103 contains the identity vectors of the complete work so that the search from measured data of the unknown program can start at the beginning, near the end (just requiring sufficient time to complete a vector sequence), or anywhere in between.

Master database 103 can be searched using the well known TRIE series of algorithms that increment a given sequence, in this case vector values, or time codes, along streams of vector numbers that are in the database. There are now more sophisticated ways a string of a few Bytes can be found to match with a database of many tens of Mega-Bytes, even when a match for every Byte is not required. When a match or near match is obtained, the identity for that sequence can be read from the auxiliary data that is associated in the database. It is analogous to digital version of a key that is successively inserted in to a lock, and when the key is pushed home the tumblers fall into place to open it. However, it is important that the algorithm allows one or more vectors to be in error and yet still obtain a match. In the event the media is played backwards in time, then reversing the sequence of vectors in a search would yield the identity of the work.

A file containing identity vectors for a media work is variable in size because it clearly depends on the duration of the program and shot changes or cuts used. In one embodiment of the present invention, for a reference program used on a two hour movie with a cut every about six seconds on average, there will be 1,200 identity vectors to be placed in master database 103. As discussed earlier, there is a 16 bit or two Byte counter as the master for counting the pictures between shot changes that is used to acquire the vector values for database 103. Thus in this typical example, there would be 2,400 Bytes of identity vector data in the file for this particular program. The numbers would be from one to 65,535 but the latter figure is extremely unlikely as discussed above. Average motional media statistics counts above 255 will also be much less frequent than those from one to 255. A count of zero is forbidden and, since it is very important to reduce the data that is in database 103, the forbidden number zero can be used to effect a data reduction.

### EXAMPLE 5

The following example provides a summary of the statistics obtained from 80 NTSC movies and TV programs that have been obtained so far. In this example, the average length of the programs is 108 minutes 36 seconds. The average number of shots per movie is 965.2625 the total number of pictures is 15,624,834 and there are 77,221 shots. The total number of seconds is 521,349. The average number of pictures in a shot is 202.3392 of duration 6.745 seconds.

79% of shots contain less than 256 pictures each, (1 Byte); 93% less than 512 (2 Bytes) and 98.2% less than 1,024. (4 Bytes). 0.48% of shots are longer than 60 seconds, or one minute and 0.105% are longer than 2 minutes. 0.0531% of the shots are longer than 3 minutes. If shot durations longer than one minute are ignored the average shot time is 6.175 seconds, or 185.06 pictures.

The 80 movies were extracted at 24 frames/second and some frames are interpolated or repeated to give the display rate of 29.97 pictures per second for NTSC.

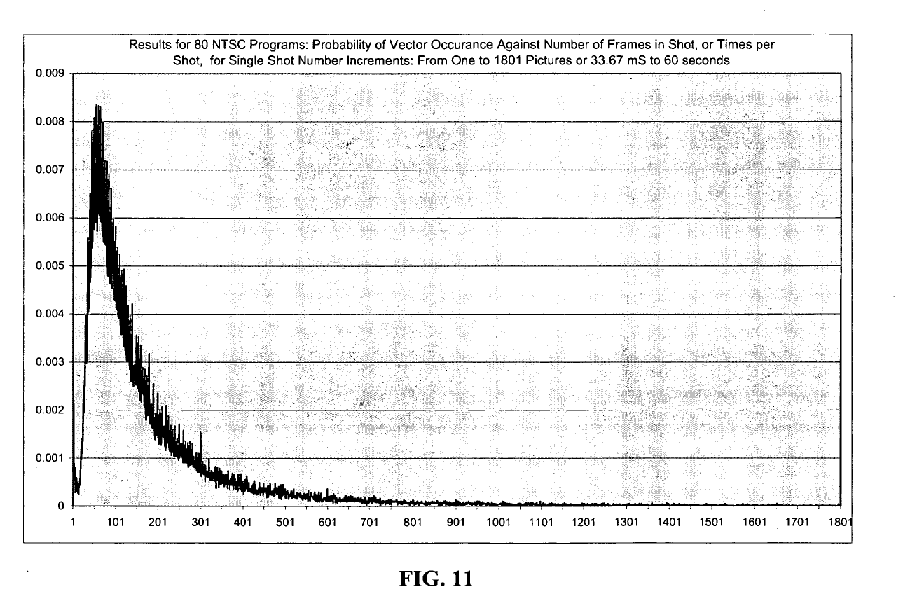

FIG. 11 illustrates a plot of probability of occurrence of each single shot versus the number of pictures in a shot, in one picture or 33.367 millisecond increments, out to 1801 pictures/shot or about 60 seconds per shot duration. It is useful to look at the general equation for the probability curve. It is derived from a smoothed curve and is integrated using half second or 15 picture bins. This equation is only approximate, and as more results are obtained will undoubtedly change. It will also be different for different genre's of the content, and may be useful, when it is refined more, to even discover the genre automatically. It is placed here just for the general reasons of improving the understanding of the nature of TV and Movie programs and concept of this invention. The equation ignores picture counts above 600 per shot. (20 seconds). Clearly the frequency peak of 1 to 6 pictures per shot are all summed together in the first 15 picture or half second bin. This equation fits the 15 bin histogram curve out to the bin number 600, with a correlation coefficient of 0.997733 and a standard error of 144.93.

$$y = {ⅇ}^{( a + \frac{b}{x} + c {log}_{e} x )}$$

$$y = {ⅇ}^{( 23.97394 - ( \frac{193.97784}{x} ) - 2.8971426 {log}_{e} x )}$$

$$a = 23.97394$$

$$b = - 193.97784$$

$$c = - 2.8971426$$

Where y is the probability of occurrence, derived from each bin of 15 vectors, in an exponentially smoothed continuous curve specified by the value of x, where x is the number of pictures in a shot. A similar curve can be created in which the probability of occurrence is plotted as a function of the duration of each shot, specified by x in seconds.

There are 3,160 results for correlation coefficients when comparing all 80 movies to each other in pairs (i.e., 79+78+77+ . . . +2+1=3,160). A simple arithmetic addition of all the correlation coefficients of every movie compared to every other, minus the self-correlations of 1, (Total 79) divided by 3160 gives a mean correlation coefficient of 0.006272123. This is not a proper statistical result, but is given as an indication of the trend that the data has a low average correlation. In other words programs, even when compared to all the other programs have a very low correlation—excerpts from each one have a high degree of uniqueness.

Table 7 provides values of the reciprocal of the probability of occurrence for each shot number, to relate that number to the actual shot number (or number of pictures in the shot). This gives approximate multipliers so that running calculations of probabilities can be calculated, using this look-up table, as any given sequence of measurements is made. Table 7 can be used as a look-up table for Number of Pictures in a Shot as a Function of the Inverse Probability of Occurrence, for NTSC TV. Values in Table 7 are taken from Frequencies in One Picture Increments.

TABLE 7

| Range for | Reference | | | | |
|---|---|---|---|---|---|
| Pictures in Shot, | Measured | Moving | Moving | Ratio: | |
| Or Frame | Number of | Average of | Average of | Inverse | Rounded |
| Numbers | Pictures in | Probability | Inverse | Probability | Multiplier for |
| to use for | Shot | Of | Probability. | Divided by | Shot Number |
| Last | (Shot | Occurrence | One Part | Shot | to give Inverse |
| column | Number) | of each Shot | in . . . | number | Probability |
| 8-22 | 15 | 0.000333 | 3000 | 200 | N/A Data |
| 23-37 | 30 | 0.002703 | 370 | 12.3 | N/A Data |
| 38-52 | 45 | 0.005435 | 184 | 4.09 | 4.1 |
| 53-67 | 60 | 0.006493 | 154 | 2.57 | 2.5 |
| 68-82 | 75 | 0.005814 | 172 | 2.29 | 2.3 |
| 83-97 | 90 | 0.005050 | 198 | 2.20 | 2.2 |
| 98-112 | 105 | 0.004386 | 228 | 2.17 | 2.1 |
| 113-127 | 120 | 0.003861 | 259 | 2.16 | 2.1 |
| 128-142 | 135 | 0.003205 | 312 | 2.31 | 2.3 |
| 143-157 | 150 | 0.002778 | 360 | 2.40 | 2.4 |
| 158-172 | 165 | 0.002427 | 412 | 2.50 | 2.5 |
| 173-187 | 180 | 0.002110 | 474 | 2.63 | 2.6 |
| 188-202 | 195 | 0.001634 | 612 | 3.14 | 3.1 |
| 203-217 | 210 | 0.001605 | 623 | 2.97 | 3.1 |
| 218-232 | 225 | 0.001410 | 709 | 3.15 | 3.1 |
| 233-247 | 240 | 0.001190 | 840 | 3.50 | 3.4 |
| 248-262 | 255 | 0.001164 | 859 | 3.37 | 3.4 |
| 263-277 | 270 | 0.000973 | 1028 | 3.81 | 3.8 |
| 278-292 | 285 | 0.000930 | 1075 | 3.77 | 3.8 |
| 293-307 | 300 | 0.000832 | 1202 | 4.01 | 4.0 |
| 593-607 | 600 | 0.000220 | 4545 | 7.57 | 7.5 |
| 743-757 | 750 | 0.000142 | 7020 | 9.36 | N/A Data |
| 868-882 | 875 | 0.000078 | 12870 | 14.7 | N/A Data |

To obtain the approximate probability (±15%), using Table 7, for an individual shot with a given number of pictures, multiply that number by the appropriate last column value and take the reciprocal. The exponential fit moving average value given in column three is the actual measured value at the shot number given in column two. The shot with the measured moving averaged value for the maximum probability contains 64 pictures and is 0.006803. The inverse probability so obtained is 147, (Ratio 2.297). This the largest probability value obtained from all the shots in the 80 movies, given the somewhat limited data set. That is, all other shots are less probable to occur.

Instead of recording two Bytes for each data entry, all vector values of or below 255 will be logged as a single Byte. When the occasional count above 255 is measured, two bytes will be placed in the database, and the forbidden value of zero can be used to precede and indicate that the following two bytes are from the same number and not two separate entries. In other words, a Byte with a forbidden value of zero is used to indicate that a two Byte number follows immediately. The next successive byte becomes a single Byte number again, until the next two Byte number is measured by inserting a zero Byte one more time to indicate the next two Byte number. The process is repeated for the entire file.

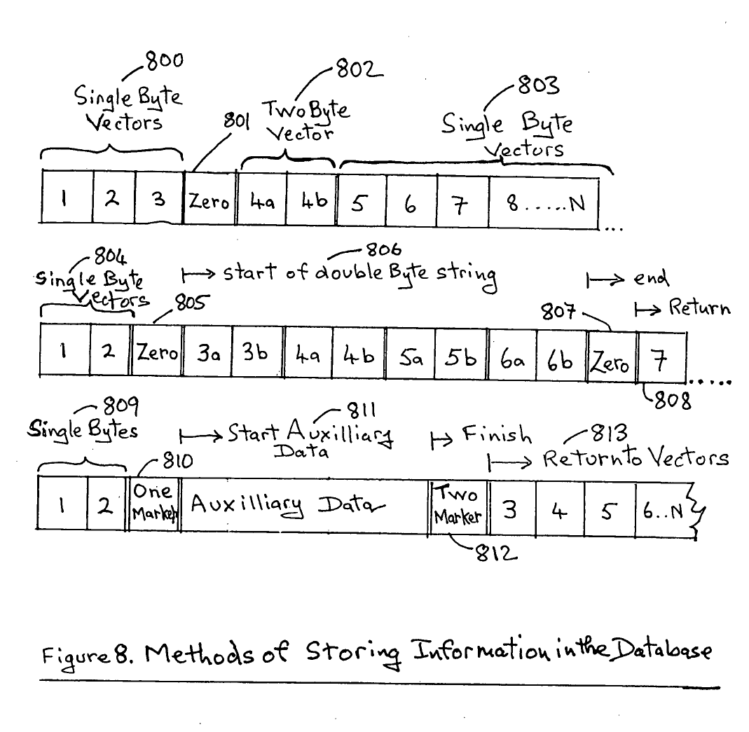

Data that is transferred to database 103 is a little more than halved and is based on the number of vectors greater than 255 that must be logged. For a movie, a vector of 255 corresponds to about 10.6 seconds between shots and shots longer than this are much less frequent. First line in FIG. 8 illustrates an exemplary method of arranging a reduction in the logged data. Bytes 800 represents single byte vectors numbered 1, 2, and 3. Fourth vector 802 is greater than 255 so requires two Bytes 4a and 4b. Byte 801 equal to zero is inserted in the sequence before 4a and 4b to indicate that a two Byte number follows Bytes 800. Bytes 803 represent Bytes 5 through N of normal single Byte numbers.

In one embodiment of the present invention, when there is a succession of long shots involving a series of vectors greater than 255, one zero indicator can be used to indicate that all the following Bytes must be taken in pairs. A second zero Byte is then used to indicate the end of double Byte numbers and return to single Byte numbers again. Second line in FIG. 8 illustrates this method. Bytes 804 represent single Byte vectors 1 and 2. Zero Byte 805 indicates that a double Byte string follows and that numbers 3a, 3b, 4a, 4b, 5a, 5b, 6a and 6b are succeeded by a second zero Byte 807. The next entry after this Byte returns all the following values to single Byte numbers again.

Embodiments of the present invention save data by minimizing the use of the zero byte indicators. For example, if five successive vectors require double byte words, this technique would use 12 Bytes, instead of 15 Bytes, with the total including the two zero byte indicators thereby saving three bytes. Furthermore, in co-pending application 60/792,749, titled “System and Method for the Identification of Motional Media of Widely Varying Picture Content,” a method is described that forbids low numbers such as zero, one, two or three as a vector value by means of a special technique. Thus, there are many degrees of freedom using auxiliary information for these methods of data reduction. FIG. 8 also shows the insertion of auxiliary data on line three. Bytes 809 represent single Byte numbers and Byte 810 has a forbidden value of one that indicates the start of a string of auxiliary information. The end of the string is remarked by a Byte 812 that has a forbidden value equal to two, followed by Byte 813 that are single Byte numbers representing the values of identity vectors.

In one embodiment of the present invention, data reduction is achieved by dividing the vector file by two, with odd number values alternatively rounded up and down, such that the total picture count for the program remains within plus or minus one picture at the end of the file. Applying this method, a vector of value 510 would be logged as 255 requiring one Byte, and a vector of value 471 would be logged as 235 or 236 based on whether the previous number in the sequence had been rounded up or down respectively. In this situation, the number of double byte numbers would be further reduced in order for shot changes to occur longer than 21.25 seconds for movies, or 17.0 seconds for NTSC, and to require that a two Byte number be placed in the database. The rule for rounding up or down a number would be obeyed in the same way. In another embodiment of the present invention, data reduction is achieved by dividing the values by four or more. In yet another embodiment of the present invention, data reduction is achieved by dividing the values by odd divisors like three or five. The latter embodiment would require the rounding rule to be modified and be slightly more complicated since rounding would now be plus or minus one or two. Therefore, to keep the running counts correct both ones and twos are carried forward to adjust the subsequent logged numbers. In embodiments of the present invention where values are divided by four ones, twos and threes are carried forward and so on. In some embodiments, dividing by even numbers is preferred because such an approach is very simple with digital signals.

### EXAMPLE 6

The following example illustrates a method using a division by two for vector numbers chosen at random.

| | | | | | | | | | | |
|---|---|---|---|---|---|---|---|---|---|---|
| Measured value: | 86 | 102 | 143 | 97 | 158 | 151 | 64 | 130 | 109 | 122 |
| Divide by two: | 43 | 51 | 71.5 | 48.5 | 79 | 75.5 | 32 | 65 | 54.5 | 61 |
| Logged value: | 43 | 51 | 71 | 49 | 79 | 75 | 32 | 65 | 55 | 61 |

When the first measured odd number in the series divided by two is rounded down and the next odd number is rounded up thus keeping the total picture count constant. There would only be zero or, at maximum, one picture in error in the picture count for the whole work. In other words, for a typical media one picture in about 100 to 200 thousand or more. This is clearly a negligible error, but the method is powerful to reduce the number of double Byte words in the file.

Database search method would be modified and measured vectors would be divided by two using, for the example, method described above. However, it would not be known where the search starts in the overall media sequence. The measurement process often has a random start position. This means that when an odd number occurs it will not be known whether the corresponding vectors in the database was rounded up or down. A search is made to obtain a match with each odd number rounded by plus or minus one-half and tested if a perfect match for a sequence is required. However, this is not necessary if a fuzzy logic approach is performed for the reasons discussed next.

Although, all vector values in a sequence, according to various embodiments of the present invention, may be in error, an identity can still be established for the media with a high degree of certainty. For example, suppose all the measurements in a sequence of seven vectors were low, high or both by 10%. Then, each vector number would be at or between 0.9 to 1.1 times the correct values respectively. Seventh powers of these ratios are 0.478 and 1.95, and the numbers divided give a value of 4.0743. If both extremes occur in the sequence, then the probability of a false positive is reduced by about a factor of two or four. Since the probabilities obtained from a vector sequence have been shown to give very large numbers, a reduction of about two or four to one does not materially affect the certainty of the identity. Further, the measurement of one more vectors of the unknown excerpt will reduce the probability of error by at least a factor of 100.

In another embodiment of the present invention, data reduction is achieved by using differential values for successive words in the database that are the difference between vectors rather than the values themselves. This technique would start the file of a given media program with the actual vector value and the difference between that value and the next value would be inserted as the second word. Similarly, the difference between words two and three would be the third word that is in the database and so on for the whole vector file. Difference values would be positive or negative depending whether successive vectors are larger or smaller than the immediately previous one. By this methodology, there would be a large data reduction for shot changes that were of similar duration, particularly if it is optimized and used with Hamming techniques and tables. The amount of compression in these types of technique relies on there being a statistically as small a distance as possible between successive values. A division reduces these distances by a factor of two, and when used in combination would give the further possibility of a useful gain in compression of the data.

With files generated using methods discussed above, normal data compression techniques can then be employed that are in common use today such as Zip®, WinZip®, or 7-Zip® methods. Hamming trees may be constructed to enable yet farther data reduction. A discussion on these methods is beyond the scope of this invention. Moreover, information related to data compression are available in the public domain and one skilled in the art will be able to create workable and efficient data compression systems by the use of these well known techniques.

Using the methodologies disclosed in various embodiments of the present invention, data for a program could be reduced to less than one kilobyte for an average two-hour program. This is equivalent to a data compression ratio relative to the original MPEG-2 movie, such as may be from a DVD, of more than several million to one. Lower and higher ratios can be obtained depending on the content's scene changes and source quality, or total capacity and duration of the particular media program.

Data compression for the database is an important issue for this invention since it is an object of the present invention that devices without Internet or database access can have an internal nonvolatile database of many tens of thousands of programs. Roughly 600 Mega-Bytes would be required for about 600,000 programs, which is a large fraction of about all the major motional media that has ever been created. (Excluding the day-to-day TV programs). 600 Mega-Byte non-volatile memories (popularly known as “Jump Drives”, “Memory Sticks” or “San Disks”) are becoming reasonably priced in the market place, and Four Giga-Bytes devices are starting to be available. In the case of hard disc products, a track would be allocated for this information on the hard drive. Some optical disc machines are now appearing with hard disc drives built into them. For the stand alone player/recorder, in general, there is no need to have the identity of one half million programs. Only the most popular media and the recent releases would be required, and only several tens of thousands would be required as a practical matter.

Associated with each entry for a given media program is the ancillary data such as the copyright holder, owner, artist details, date of copyright and other information. Important information for the consumer is background information on the artists, the director, producer, locations used in the work and other information of interest. There is no limit to the amount of additional information that can be inserted by the database owner. One embodiment of the present invention includes the latest data on the artists and movies that also may be liked by the consumer of the same genre or with the same artists and promotion items such as tickets to events or newly released movies. These are all examples of information that can be delivered to the consumer when a given media is accessed in the database, at the consumer's choice.

Additional technical information will also be placed in the database. As discussed above, total duration of the media is also an important parameter for determining the probability of an assured identity. As another example, information concerning the rights of the copyright holder or owner of the work is also an important parameter for determining the probability of an assured identity. Further, the holder may wish to restrict the use and distribution of the program. There are proposals within the media industry that are published which, for instance, would not allow secondary distribution, making one or several copies, and similar regulations. Details of the proposal can be found in a document titled “Request for Expressions of Interest,” dated Oct. 26, 2005, issued by the Motion Picture Association of America (MPAA) and the DVD Copy Control Association, (DVD CCA), the contents of which is incorporated herein by reference. This document specifies that at least two bits of CCI (Copy Control Information) data be included in the technology. Three of four possible states are defined, Copy Never: Pre-Recorded media, No Home Use and Copy Never: Trusted Source. The ease of detection of the codes and robustness requirements are discussed as false positives of less than one part in 10¹² (One part in one Trillion).

Master database 103 allocates the use limitations, such as CCI data, to each particular work and sends codes representing this information automatically to the consumer when the database is accessed. Further, regulation such as these can be used to monitor legal and illegal distribution of the information on the Internet, by inspection of media data streams, acquiring the identity with a data search and looking up the associated copyright holder's information to determine the legality of the distribution.

Such data can be updated dynamically. For example, a program when it is first released may have very tight regulations as to its usage. Later in its distribution cycle or copying, restrictions may be, and are often, relaxed. The database must have such latest information to update the earlier now invalid information. Another example is where the work that enters the public domain when it's copyright has expired. Such information is placed in the database to prevent illegal restrictions on a work that should otherwise be without any such constraints.

It is another object of the present invention that specially designed software and hardware visual and audio media players have the ability to automatically access master database 103. Master database 103 may be accessed via the Internet, or wireless links that may also use the Internet and mobile devices that may use cellular, television-cable, satellite or other systems. Any communication means maybe used to establish connection with database 103, such that the information in the database is delivered to the device that made access. Media players also include audio media for speech, songs and music. Alternate embodiments of the present invention can be used media players, such as cell phones, PDA's, Automobile receivers, iPOD®'s, Zune®'s, Satellite receivers, Set Top boxes, DVR's, and the like. As discussed herein, the purpose is to access information about the visual media that is downloaded, or by any means is about to be played or stored for later use. Master database 103 starts with the process of identifying the media. Identity can be achieved from the subject matter of these inventions, or may be available by other means. For example, if a disc is being played then codes on that disc can be used to effect identification. Alternatively, Table of Contents (TOC) on the disc, or the timing positions of the chapters of movies can be used. There are other ways that identities may be established for movies made for TV for instance. However, embodiments of the present invention provide simpler methods to identify media. Further, in most cases, the methods disclosed by the present invention will be the only way to identify content since the information will not be available, such as in the case when the file is transmitted over the Internet. To discover the identity of the content by analysis of the pictures is therefore very powerful. After the database is searched and the identity is established, information about the particular media is downloaded to the device making the request. The first set of data supplied is permissions and CCI information, so that the authenticity of the program and its subsequent use is established. This may be in coordination with legal and secure download software such as a Digital Rights Management (DRM) system.

The next functions from the database are optional and are made automatic with selection by the consumer that may have been made when the consumer first set up access facilities and options. Principal amongst the extra facilities is information about the identified media including but not limited to title, artist, producer, and director information. Date and place of production, the latest details about the artist and actors, the type of genre and media in similar categories, clips or out-takes that were made when the work was being created and so on.

Another purpose of this information is to enhance the consumer's knowledge and enjoyment of the program and widen education about media in general.

Another important aspect is that master database 103 can supply promotional facilities, for example the latest information about the stars of the movie and what they are working on at present, tickets to new releases, shows or benefits that they will be present at and many legions of other interesting data.

All these systems work in the background so that if the choice is to just watch and listen to the program this happens without interruption. If the media is being watched while it is being downloaded then the special software in the media player will parse the auxiliary information such that the continuous content data stream is not compromised.

For systems such as computers that have high capacity disc or ROM drives, there may be several media items that do not have proper identifications and without the other facilities of data discussed above. Software, firmware and/or hardware in the player can be used to identify the media by the subject matter of these inventions or other means and then supply the auxiliary information including permissions and promotions. Further, the software can organize the media into a table of contents in alphabetical order, date, or by genre as examples. Instead of a program being identified by files anonymously labeled such as “movie 1” etc., as so often happens in a typical consumer computer, a properly organized file structure with the title and other information is downloaded and organized automatically. All this activity is facilitated again in the background without interference with the current activity of the host device. Most importantly the user is not required to perform any action, other than to request or agree to the actions when an appropriate dialog box appears. Other facilities may be programmed in the media player such as the acquisition of latest updates for the organized files in the receiving device each time the player is loaded. Mobile devices can be loaded with software that offer some or all of the facilities that can be done directly via the wireless connections or by a computer before or after the transfer of the media file is complete. (The latter is useful because many mobile devices exchange media with computers and often computer downloads are economical due to available data-space and lower costs. Transfers between equipment are then facilitated via interfaces or devices such as non-volatile RAM, ROM or hard drives.)

Although information and permission/regulation data can be accessed automatically using appropriate software on computers, telephones or mobile wireless devices, stand-alone player or media recorder cannot access master database 103. These stand-alone player or media recorder will not be able to access the data and therefore may not have access to the codes that regulate the usage of the media in question. Therefore, the use of media on DVD and new technology players and recorders is potentially unregulated.

A similar problem exists for hard disc based devices such as the TIVO® or the mobile devices such as cellular telephones, automobile players, I-Pod® (Apple Inc., Cupertino, Calif.), for video and even non-connected computers that use hard drives, non volatile or dynamic RAM for the memory storage element(s). In the market place a plethora of like devices produced by many different manufacturers are available. These devices are often able to exchange programs with computers or be recorded on other media by connecting them through high technology interfaces such as USB-2 and the IEEE 1394 interface popularly known as “Fire Wire” or wireless interfaces and others. With the advent of the next generation of optical disc technology, such as the Blu-Ray consortium devices and HD-DVD forum that are going to be able to distribute, play and record High Definition Television (HDTV or HD), the problem of unregulated program usage will be exacerbated. Such consortia have produced several variants of new protection specifications known as the Advanced Access Content System (AACS).

In normal distribution with legally allowed downloads or optical discs, there are means to regulate the usage of the media by distribution of the appropriate permissions by the owner of the work, or their licensed distribution agents. The codes such as CCI that regulate permissions are contained in the digital data stream for file downloads. They are read and interpreted by the media software that is used to play and store the works. Similarly codes exist on the optical discs that are sold or rented and, again, these are read and interpreted. In general, they are coupled to the media file identity and encryption methods so that a robust system of regulation is employed.

However, illegally produced files or discs, not limited to “bootlegs,” usually do not have these permissions or rules built in to them. Consequently, they escape appropriate regulation. Further, stand alone players, devices or recorders not connected to the Internet have no means to regulate such illegal distributions, and copies for secondary distribution can be made at will.

It is at least one feature and advantage of this invention that a stand-alone unit can have the identities of many thousands of media loaded within it at the time of purchase, or can be loaded later together with auxiliary information. This is possible because of the extremely large data compression of identity data with the presently described invention. When a disc is played, simple algorithms are employed to search the local database in the machine, an identity is established and associated auxiliary information is accessed. In addition to information of interest for a consumer, permissions for the media will be read. For example, if the media is an illegal copy, then permission to play or copy that media can be prevented. This may happen if the normal controls that are part of the DVD or newer optical disc protection systems have been circumvented, or if the zone for the media's distribution has not been established yet in the location of the player or recorder. Such a copy of the master database in the machine can be kept up-to-date.

When a new media disc that is purchased or rented is played on a machine, a data track on that media can have the identities of all the latest releases on a special data track on the disc. Further, the permissions for files already present on the disc can be updated with the latest information. DVD, HD and Blu-Ray discs have provisions for placing auxiliary data tracks in their standards or developing standards.

Since the memory allocated for the internal database is finite, there will be a point where it becomes full or nearly full of data. At that time, older or less popular items, as determined from marketplace statistics, can be discarded and action there from placed on the update track on the new media.

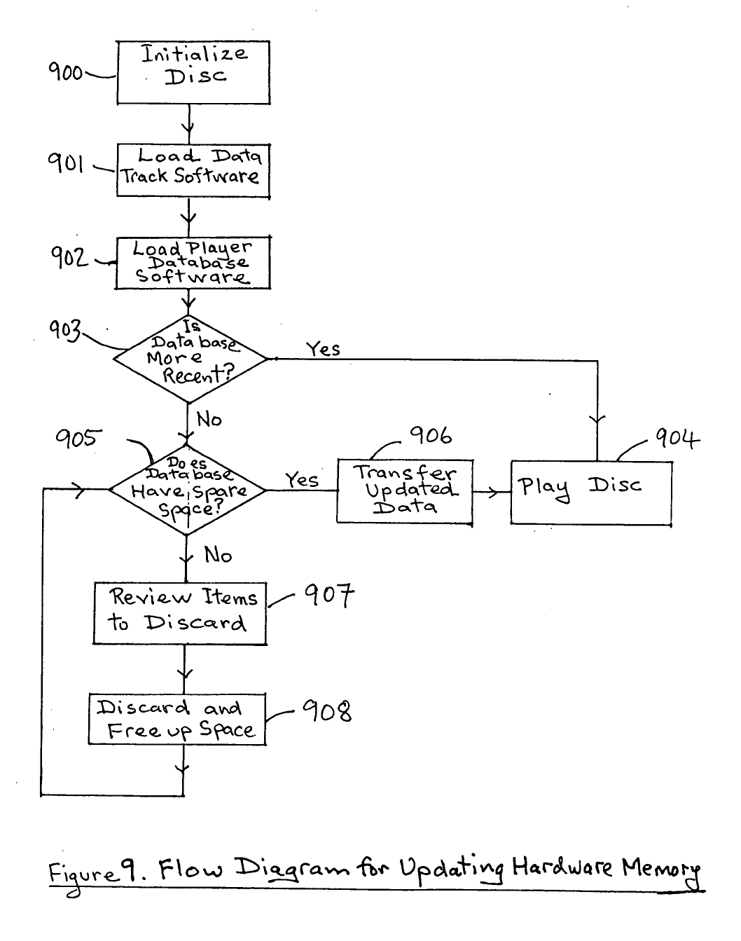

FIG. 9 provides an exemplary flow diagram for the method disclosed by the present invention. At step 900, a disc containing the special data track is initialized and the table of contents (TOC) for the disc is read when the disc is inserted in the machine. At step 901, the disc then loads the data track software for authentication and decryption key exchanges. The disc software requests that the internal software is loaded at step 902, which then manages the database. A check is performed at step 903 to verify whether the data on the disc is more recent than data in the database 103. If database 103 is more recent than the disc then, at step 904, the disc moves directly to the operator's command to play the media. If the disc has more recent data then, at step 905, a request is sent to verify whether there is sufficient capacity in database 103 to accept the update. If space is available then, at step 906, data to update the memory is transferred to the internal database. In one embodiment of the present invention, data to update the memory includes updated permissions, auxiliary information and latest promotions with artist information. If space is insufficient then, at step 907, a review of earlier and unused items, or statistically less frequent items from the market place, or items now in the public domain, or similar reasons are all reviewed for erasure. The software then erases the selected entries at step 908, and returns to step 905 to verify whether there is sufficient capacity available to accept the new data from the disc. If the capacity is insufficient, the review is repeated. If there is sufficient capacity then, at step 906, data is transferred and the action to play the disc is performed.

All of these functions are advantageously in at least one embodiment executed without operator input, and would be extremely rapid so that the consumer is not significantly kept waiting to play the media that was inserted. Using the system and method disclosed in embodiments of the present invention, stand-alone players could be updated often and, when a new status for the permissions is established, they could be transferred accordingly. Embodiments of the present invention are therefore able to adjust permission when necessary so that if an object's copyright has expired the new public domain rights would be ensured.

All functions discussed above can be incorporated in ROM drives such as CD or DVD-R or CD-RW units or computer optical or removable hard disc media drives. The media player software would access these drives that were specially designed to facilitate access to motional media.

In another embodiment of the present invention, updated data are uploaded using Universal Serial Bus interfaces (e.g. USB1 and USB-2), or other similar interfaces in home, mobile or automobiles. Non-volatile memories can be pre-loaded with the necessary identity and auxiliary data and up loaded to the units via the interface. This allows the database in the machine to be kept current without the use of a special track on a pre-recorded disc. In practice, both methods may be the optimum system for a product.

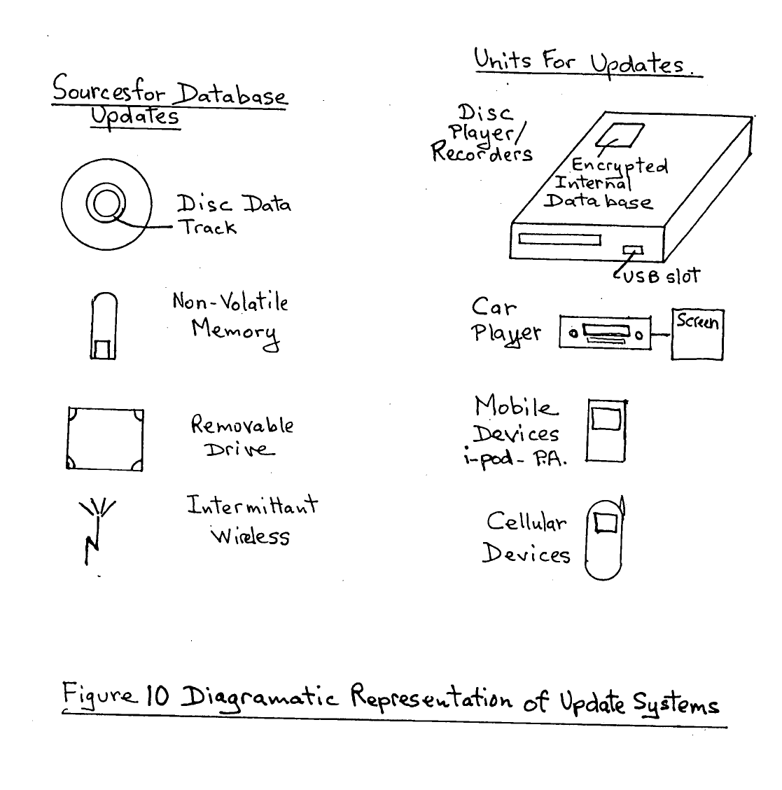

FIG. 10 illustrates exemplary sources of data update. Although some devices shown in FIG. 10 could access master database 103 via the Internet, by wireless or other means, it might not be the easiest, most convenient or the most economic way of acquiring the data.

Another requirement of the internal database is that it has a special area for computer software programs that run the search and organize the acquisition of new data from the new data source. There may be improvements to the design of this software, such as without limitation the ability to search the identifiers for the media more quickly. The data track on the software or other means of receiving updates will also include the facility to update the computer software programs as well. In this way not only is the internal database kept current but the software to accomplish the system operation is also maintained with the latest improvements.

One other factor is that both the database programs and the associated software must be encrypted for protection reasons. If the operation of the database is illegally interfered with, then the system could fail.

Embodiments of the present invention can identify very large media content files with an extremely small amount of data, representing a compression of some millions to one. For example, it has been found that a 7.2 Giga-Byte MPEG-2 media file required only about 750 Bytes of compressed master database information to produce a set of identifiers for the complete visual program. The power of embodiments of the present inventions can be seen especially if it is recalled that even audio fingerprint methodologies rarely are able to compress the identifiers to more than a few thousand to one.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users. One or more embodiments of the present invention can be modified to run on any platform, such as Windows®, Appleg, Sun Systems, IBM, or use UNIX, LINUX, and/or with general or dedicated processors such as an ARM or other type of processor.

The many features and advantages of the embodiments of the present invention are apparent from the detail specification, and thus, it is intended by the appended claims to cover all such features and advantages of the invention that fall within the true spirit and scope of the invention. Further, since numerous modifications and variations may readily occur to those skilled in the art, it is not desired to limit the invention to the exact construction and operation illustrated and described, and accordingly, all suitable modifications and equivalents may be resorted to, falling within the scope of the invention.

What I claim is:

1. A method for identifying motional picture media content, comprising:
deriving at least one of a plurality of first vectors of at least one of a plurality of pictures from a first motional picture media, wherein the plurality of pictures is a sequence, and wherein the first vectors of the pictures are between shot changes;
storing the at least one of the plurality of vectors in a database;
searching the database for a second motional picture media, wherein the second motional picture media is substantially similar to the first motional picture media;
comparing the at least one of the plurality of first vectors with at least one of a plurality of second vectors of at least one of a plurality of pictures from the second motional picture media;
determining whether the at least one of the plurality of first vectors is substantially similar to the at least one of the plurality of second vectors;
retrieving identity data corresponding to the second motional picture media if the at least one of the plurality of first vectors is substantially similar to the at least one of the plurality of second vectors; and
displaying the retrieved identity data corresponding to the second motional picture media.

2. The method of claim 1, wherein the first and second vectors are counts of the pictures between shot changes.

3. The method of claim 1, wherein the first and second vectors are time codes between shot changes.

4. The method of claim 1, wherein the sequence is at least one of a continuous or discontinuous sequence.

5. The method of claim 1, wherein the identity data comprises ownership and copyright information.

6. The method of claim 1, further comprising the step of retrieving ancillary data associated with identity data corresponding to the second motional picture media.

7. The method of claim 6, wherein ancillary data comprises date of production, date of copyright, artists, director, producer and locations used in the work.

8. The method of claim 1, wherein the plurality of pictures is a substantially continuous reverse sequence.

9. The method of claim 1, wherein the plurality of pictures is a substantially discontinuous reverse sequence.

10. The method of claim 1, wherein the at least one of the plurality of second vectors of at least one of the plurality of pictures from the second motional picture media is from about 1 to about 255 counts.

11. The method of claim 1, wherein the at least one of the plurality of first vectors of at least one of the plurality of pictures from the first motional picture media is from about 1 to about 255 counts.

12. The method of claim 11, wherein the 255 counts corresponds to about 10 seconds between shots.

13. The method of claim 1, wherein the at least one of the plurality of first and second vectors is assigned zero counts, wherein the zero counts triggers a data reduction.

14. The method of claim 1, further comprising:
restricting use of second motional picture media if the at least one of the plurality of first vectors is not substantially similar to the at least one of the plurality of second vectors;
retrieving copy control data corresponding to the second motional picture media; and
displaying copy control information corresponding to the copy control data.

15. The method of claim 14, wherein the copy control information is at least one of: Copy Never: Pre-Recorded Media, No Home Use, and Copy Never: Trusted Source.

16. The method of claim 1, wherein the plurality of first and second vectors is assigned at least two successive zero counts, wherein the at least two successive zero counts triggers recognition of ancillary data.

17. The method of claim 1, wherein the motional media is at least one of: movies, video games, computer games, television programs, advertisements, graphics and music videos.

18. A system for identifying motional picture media content, comprising:
a programmable storage media comprising a first motional picture media;
a media player for deriving from the programmable storage media at least one of a plurality of first vectors of at least one of a plurality of pictures from the first motional picture media, wherein the plurality of pictures is a continuous sequence, and wherein the first vectors of the pictures are between shot changes;
a communication device for communicating with at least one of a plurality of databases comprising at least one of a plurality of motional media;
a master database for storing the at least one of the plurality of vectors;
a first processor for determining whether the at least one of the plurality of first vectors is substantially similar to at least one of a plurality of second vectors of at least one of a plurality of pictures from a second motional picture media;
a second processor for retrieving identity data corresponding to the second motional picture media if the at least one of the plurality of first vectors is substantially similar to the at least one of the plurality of second vectors; and
a display device associated with the media player for displaying the retrieved identity data corresponding to the second motional picture media.

19. The system according to claim 18, wherein the media player is capable of reading and/or writing at least one of: CD video (CDV), Digital Versatile Disc (DVD), High-Definition DVD (HD-DVD), Blu-ray discs (BD), Digital Video Recorder (DVR), Random Access Memory (RAM), Read-Only Memory (ROM), magnetic storage media, or a flash memory device.

20. The system according to claim 18, wherein the media player analyzes content of the programmable storage media in about real time.

21. The system according to claim 18, wherein the media player is capable of analyzing content of a motional media stored on a remote database accessible via the Internet.

22. A method for identifying motional picture media content, comprising:
deriving at least one of a plurality of first vectors of at least one of a plurality of pictures from a first motional picture media, wherein the plurality of pictures comprises a sequence of the first motional picture media, and wherein the first vectors of the pictures are substantially between at least one of shot and/or event changes of the first motional picture media;
searching at least one database for a second motional picture media, wherein the second motional picture media is substantially similar to the first motional picture media with reference to said identifying; and
controlling use of the first motional picture media responsive to a comparison of the at least one of the plurality of first vectors to at least one of a plurality of second vectors of at least one of a plurality of pictures from the second motional picture media.

23. The method of claim 22, further comprising:
restricting use of the first motional picture media if the at least one of the plurality of first vectors is not substantially similar to at least one of a plurality of second vectors of at least one of a plurality of pictures from the second motional picture media; and
displaying copy control information corresponding to the second motional picture media to a user for controlling access to the first motional picture media.

24. The method of claim 22, wherein the first and second vectors are counts of the pictures between shot changes.

25. The method of claim 22, wherein the first and second vectors are time codes between shot changes.

26. The method of claim 22, wherein the sequence is at least one of a continuous or discontinuous sequence.

27. The method of claim 22, wherein the identity data comprises ownership and copyright information.

28. The method of claim 22, further comprising the step of retrieving ancillary data associated with identity data corresponding to the second motional picture media.

29. The method of claim 28, wherein ancillary data comprises date of production, date of copyright, artists, director, producer and locations used in the work.

30. The method of claim 22, wherein the at least one of the plurality of first and second vectors is from about 1 to about 255 counts.

31. The method of claim 30, wherein the 255 counts corresponds to about 10 seconds between shots.

32. The method of claim 22, wherein the at least one of the plurality of first and second vectors is assigned zero counts, wherein the zero counts triggers a data reduction.

33. The method of claim 22, further comprising:
retrieving identity data corresponding to the second motional picture media if the at least one of the plurality of first vectors is substantially similar to the at least one of the plurality of second vectors; and
displaying the retrieved identity data corresponding to the second motional picture media.

34. The method of claim 22, wherein the plurality of first and second vectors is assigned at least two successive zero counts, wherein the at least two successive zero counts triggers recognition of ancillary data.
